(19) United States
(12) Patent Application Publication
(10) Pub. No.: US 2013/0305149 A1
(43) Pub. Date: Nov. 14, 2013

(54) DOCUMENT READER AND SYSTEM FOR EXTRACTION OF STRUCTURAL AND SEMANTIC INFORMATION FROM DOCUMENTS

(71) Applicant: SEC Live, LLC, Bellevue, WA (US)

(72) Inventors: Anton Rosenov Dimitrov, Varna (BG); Evgeni Nikolaev Kirov, London (GB); Keith Guerin, Seattle, WA (US); Kremena Simeonova Royachka, Varna (BG); Louis T. Gray, Bellevue, WA (US); Neil S. D. Smith, Redmond, WA (US); Slavi Marinov Marinov, Varna (BG); Todor Hristov Kolev, Sofia (BG); Valentin Stoyanov Mihov, Sofia (BG); Vladimir Krasimirov Tsvetkov, Sofia (BG)

(73) Assignee: SEC Live, LLC, Bellevue, WA (US)

(21) Appl. No.: 13/892,208

(22) Filed: May 10, 2013

Related U.S. Application Data
(60) Provisional application No. 61/645,312, filed on May 10, 2012.

(51) Int. Cl. G06F 17/21

(52) U.S. Cl. CPC G06F 17/212
USPC 715/273

(57) ABSTRACT

Embodiments of the invention disclose a method and a system for processing and reading/viewing and otherwise consuming electronic documents. Said processing may include the extraction of structural and semantic Information from documents; and displaying the documents to a viewed in an interactive manner

This application claims the benefit of priority to U.S. Provisional Patent Application No. 61/645,312, which was filed on May 10, 2012 and is hereby incorporated herein by reference.

### FIELD

Embodiments of the invention relate document readers.

### BACKGROUND

The use of electronic documents is increasing. Users (also referred to herein as “viewers” or “readers”) routinely view electronic documents relating to diverse subject matter, e.g. SEC filings, patent filings, trademark filings, etc. on an display of an electronic device such as a tablet or personal computer.

While electronic documents are easily stored, viewing and interacting (consuming) the documents remains cumbersome.

### SUMMARY OF SOME EMBODIMENTS

This Summary is provided to comply with 37 C.F.R. §1.73, requiring a summary of the present technology briefly indicating the nature and substance of the present technology. It is submitted with the understanding that it will not be used to interpret or limit the scope or meaning of the claims.

Disclosed herein is a Document Reader along with a System for Extraction of Structural and Semantic Information from documents.

### BRIEF DESCRIPTION OF THE FIGURES

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

The present invention, in accordance with one or more various embodiments, is described in detail with reference to the following figures. The drawings are provided for purposes of illustration only and merely depict exemplary embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 shows the elements of a Reader Application, a Document Processor, and a Supporting Reader Services component, in accordance with one embodiment of the invention.

FIG. 2 shows a process for inputting documents, in accordance with one embodiment of the invention.

FIG. 3 illustrates a process for document structuring, in accordance with one embodiment of the invention.

FIG. 4 shows a flowchart for creating a budget, in accordance with one embodiment of the invention.

FIG. 5 illustrates how Document Search works, in accordance with one embodiment of the invention.

FIG. 6 illustrates a User Interface (UI) for a search query, in accordance with one embodiment of the invention.

FIGS. 7-12 illustrate various ways of using the User Interface of FIG. 6 to perform searches, in accordance with one embodiment of the invention.

FIG. 13 shows an example of a List View of a User Interface generated by a Document Selection Component, in accordance with one embodiment of the invention.

FIG. 14 shows an example of a Timeline View of a User Interface generated by a Document Selection Component, in accordance with one embodiment of the invention.

FIG. 15 shows the User interactions that a Document Selection Component may support, in accordance with one embodiment of the invention.

FIG. 16 illustrates a very simple filtering UI, in accordance with one embodiment of the invention.

FIG. 17 shows a workflow for a Document Filtering Component, in accordance with one embodiment.

FIGS. 18-19 illustrate how the filtering by Document Type works, in accordance with one embodiment of the invention.

FIG. 20 shows an exemplary the Document Viewing UI component, in accordance with one embodiment of the invention.

FIG. 21 shows an exemplary Navigation Component UI in accordance with one embodiment of the invention.

FIGS. 22-23 show exemplary workflows pertaining to navigation, in accordance with one embodiment of the invention.

FIG. 24 shows a detailed view of a Navigation UI Component, in accordance with one embodiment of the invention.

FIGS. 25-32 show the Navigation UI Component in various states of transition, FIGS. 22-23, in accordance with one embodiment of the invention.

FIGS. 33-37 illustrate the behavior of Sticky Section Header, in accordance with one embodiment of the invention.

FIG. 38 illustrates an example of how a Smart Action works, in accordance with one embodiment of the invention.

FIG. 39 shows a sample screen of a Document Viewing Component along with all the elements of a Semantic Annotation Component, in accordance with one embodiment of the invention.

FIGS. 40-42 show a Document Viewer with several Semantic Annotations, in accordance with one embodiment of the invention.

FIG. 43 shows a flowchart for creating Semantic Annotations, in accordance with one embodiment of the invention.

FIG. 44 shows Smart View Component, in accordance with one embodiment of the invention.

FIG. 45 shows the Smart View Component of FIG. 44 with the View Selector not expanded, in accordance with one embodiment of the invention.

FIG. 46 illustrates a workflow behind the Smart Views Component, in accordance with one embodiment of the invention.

FIG. 47 shows a Smart View Component listing a set of Smart Views for an Annual Report, in accordance with one embodiment of the invention.

FIG. 48 shows a Smart View Component before applying any Smart Views, in accordance with one embodiment of the invention.

FIG. 49 shows a Navigation Component before applying any Smart Views, in accordance with one embodiment of the invention.

FIG. 50 shows the Navigation Component after a “Business Overview” smart view has been applied, in accordance with one embodiment of the invention.

FIG. 51 shows the Smart View Component after the “Business Overview” smart view has been applied, in accordance with one embodiment of the invention.

FIG. 52 shows the Navigation Component after a “Financial Overview” smart view has been applied, in accordance with one embodiment of the invention.

FIG. 53 shows the Smart View Component after the “Financial Overview” smart view has been applied, in accordance with one embodiment of the invention.

FIG. 54 shows the Smart View Component after the “Risks Overview” smart view has been applied, in accordance with one embodiment of the invention.

FIG. 55 shows the Navigation Component after a “Risks Overview” smart view has been applied, in accordance with one embodiment of the invention.

FIG. 56 shows a pipeline for document processing, in accordance with one embodiment of the invention.

FIG. 57 shows featurization subcomponents implemented a pipelined manner to extract features from document fragments, in accordance with one embodiment of the invention.

FIG. 58 shows a Pipeline Sequence, in accordance with one embodiment of the invention.

FIG. 59 shows a high-level block diagram of hardware for implementing at least some components of the system disclosed herein, in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### BRIEF DESCRIPTION OF THE FIGURES

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

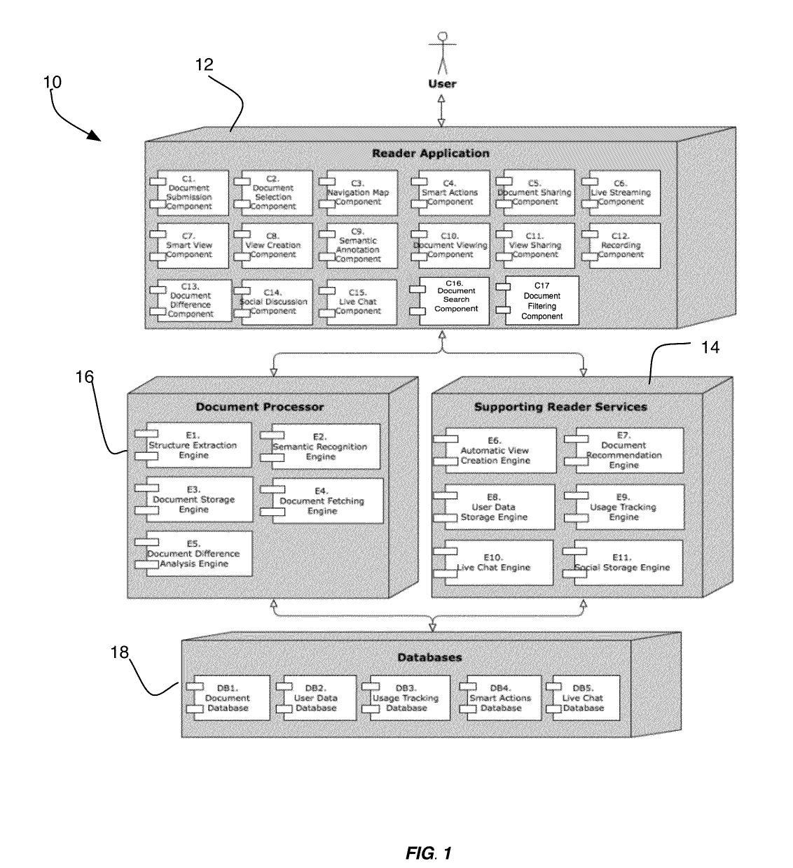

Broadly, embodiments of the invention disclose a method and a system for processing and reading/viewing and otherwise consuming electronic documents. One embodiment of the system is shown in FIG. 1 where it is indicated generally by reference numeral 10. As will be seen, components of the system 10 include a Reader Application 12 (also referred to herein as “Document Reader 12”) and a Supporting Reader Services component 14.

In one embodiment, the Reader Application 12 may be a web application, a mobile application, or an installable desktop application. Users may interact with the Reader Application 12 in order to efficiently consume electronic documents. Advantageously, said interaction include, but is not limited to reading, navigating, annotating, reviewing, curating, sharing and social enrichment of documents.

In one embodiment, the Reader Application 12 utilizes the functionality provided by the Supporting Reader Services component 14. In one embodiment, the Supporting Reader Services component 14 may reside on a separate server (or servers) than that on which the Reader Application 12 resides.

The Document Reader 12 may require information on a document's structure and semantics. This type of information may be available for some documents whereas others may be “unstructured” —e.g. the heading structure is not explicitly defined, semantically important objects are not explicitly specified, etc. Thus, in one embodiment, the System 10 includes a Document Processor 16, which is a component for extraction of structural and semantic Information from documents thereby to enable the Document Reader 12 to operate properly for such documents.

Finally, the System 10 may include Databases 18 for data storage purposes.

As shown in FIG. 1, in one embodiment, the Document Reader 12 may include the components labeled C1 through C17, the Document Processor 16 may include the components labeled E1 through E5, the Supporting Reader Services 14 may include the components labeled E6 through E11, and Databases 18 may include the components labeled DB1 through DB5.

As used herein, “Entities” may include natural objects around which documents can be grouped. Depending on the application domain the Entities could be Companies (Documents could be company filings), Authors (Documents could be books, patents, articles), or Publications (Documents could be magazine articles, newspaper articles). Each Entity has some associated domain-specific metadata, such as Name (companies, authors), Stock Symbol Ticker (companies), Title (book, magazine, newspaper), and many others.

Each Document may include supplementary metadata, such as a Document Type and a Publishing Date.

The system 10 may perform various operations on and in relation to documents. These operations will now be described.

### Document Input

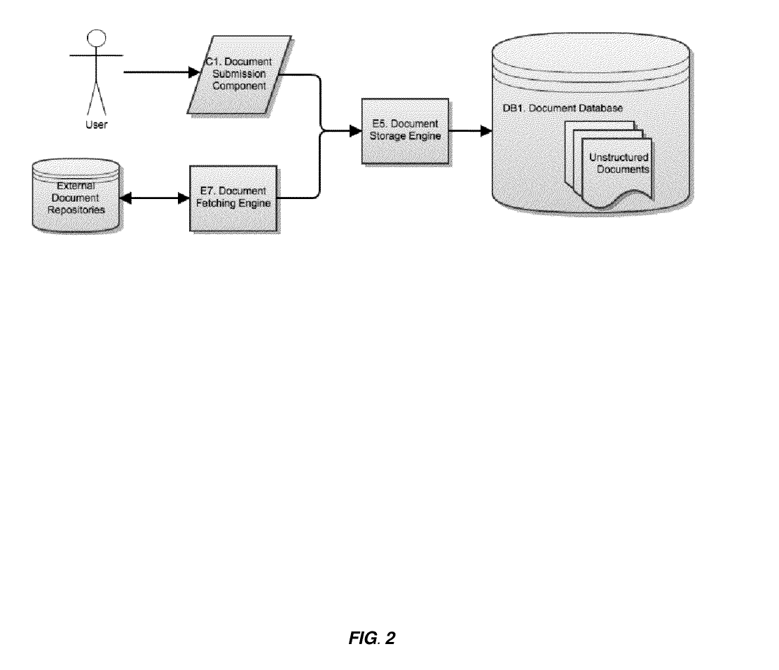

Documents may be fed into the System 10 in two ways. Firstly, by a user using the Document Submission Component C1, or secondly by the Document Fetching Engine E4. The process of inputting a document is illustrated in FIG. 2.

The Document Submission Component C1 allows the user to select a document on their computer or directly on the Internet (using the document's URL) and to submit it into the System 10. The user indicates that they would like to upload one or more documents by clicking an “Upload” button. The Document Submission Component C1 shows a dialog that allows the user to select one or more documents from their local storage, as well as provide links to documents on the Internet. Once they are selected, the user clicks “Done”. The Document Submission Component C1 then passes the submitted documents to the Document Storage Engine E5.

The Document Fetching Engine E7 may run regularly or on demand and based on certain rules it fetches documents from external document repositories. Once each document is fetched, it is passed to the Document Storage Engine E7.

External document repositories may include FTP sites, relational and non-relational databases, cloud storage, and others. These repositories are located somewhere on the Internet, and some may require that the Document Fetching Engine E7 be properly authenticated. Through standardized communication interfaces (specific for the each kind of repository), the Document Fetching Engine E7 may connect to each of these repositories. Once connected, the Document Fetching Engine E7 identifies modifications to the documents in the repository, and synchronizes the changes with its local storage.

The Document Fetching Engine E7 may be configured to run either regularly (every month, every day, every hour, etc.), or “on demand”. The latter can occur in cases such as an administrator manually requesting a set of documents to be fetched, or another system alerting the Document Fetching Engine that documents should be fetched.

In one embodiment, the Document Fetching Engine E7 may not always fetch all documents on the repository. To provide flexibility and granularity, it allows for rule-based configuration, which instructs it what documents to fetch. Examples include fetching only documents created during a certain date range, documents created by a certain set of authors, documents within a certain set of folders, documents of particular type, and many others. The Document Fetching Engine E7 may recognize these rules and operates based on them, in one embodiment. The Document Storage Engine E3 may be configured to take documents passed to it and stores them in the Document Database DB1.

### Document Processing

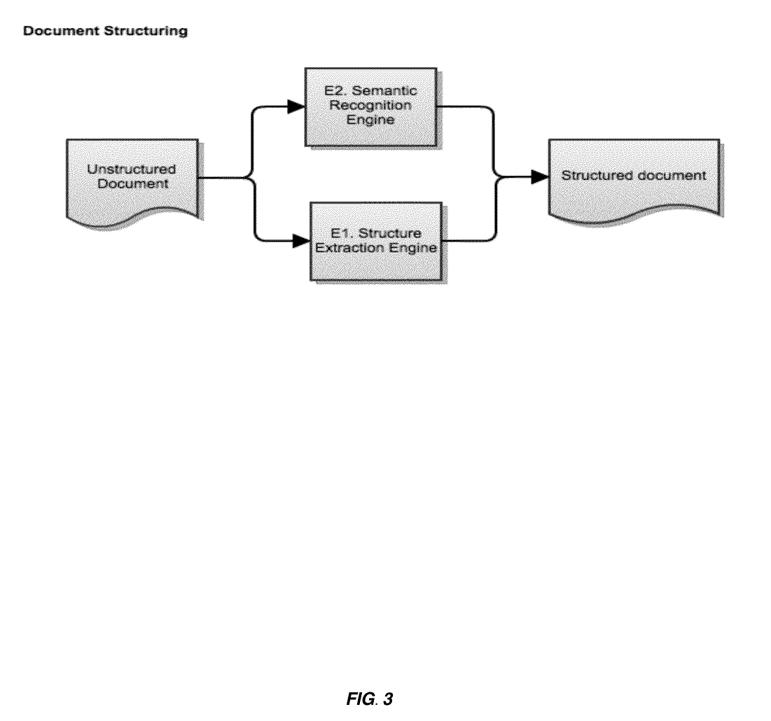

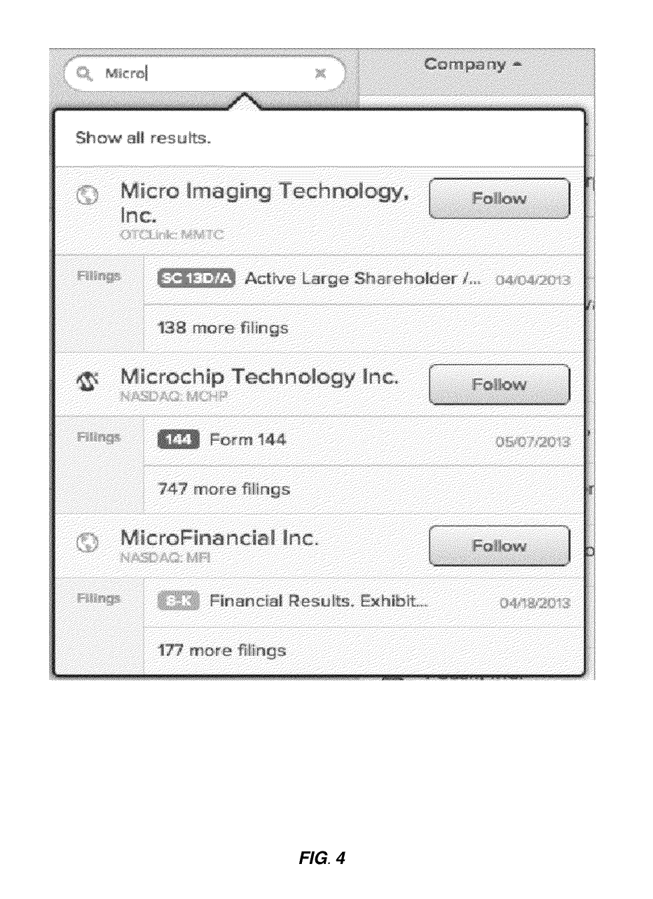

Documents stored in the Document Database DB1 may be processed by the Structure Extraction Engine E1 and the Semantic Recognition Engine E2, in accordance with the document structuring process shown in FIG. 3. The Structure Extraction Engine E1 automatically extracts the structure of a document. The “Structure” of a document includes all levels of headings within the document, as well as their nesting. The Semantic Recognition Engine E2 may recognize specific embedded objects. Such objects may include, but are not limited to tables, table footnotes, images, movies, page headers, page footers, and unhelpful “noise”. Both of these engines can use techniques such as machine learning, natural language processing, heuristics, greedy algorithms, dynamic programming algorithms and others to do their job.

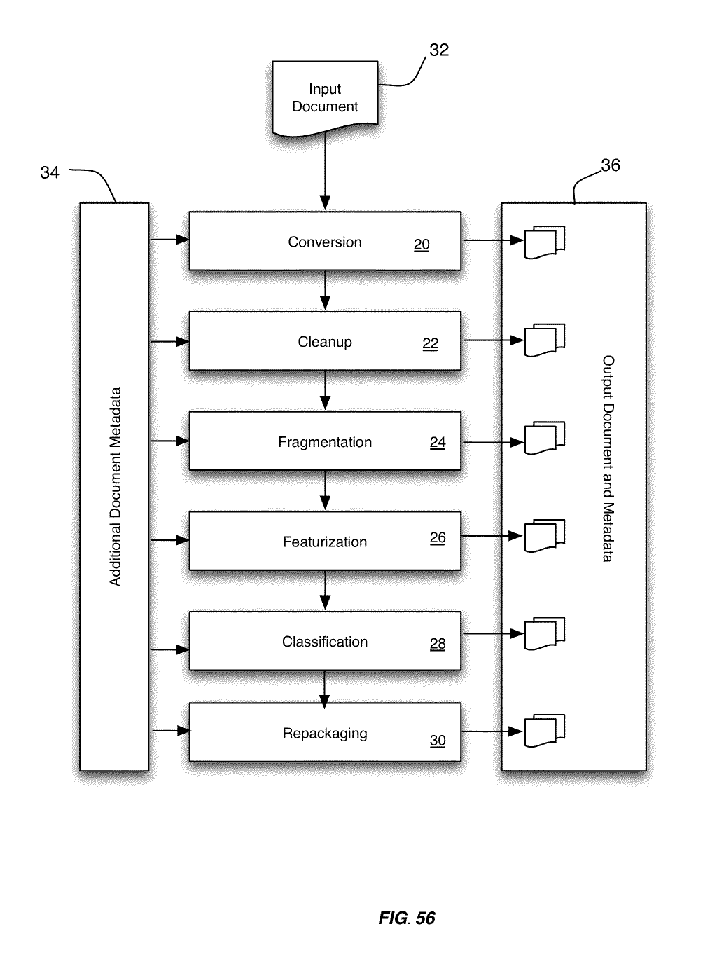

Both the Structure Extraction Engine E1 and the Semantic Recognition Engine E2 utilize a Document Processing Pipeline Method (referred to as the “Pipeline” below for brevity). In one embodiment, the Pipeline may include a series of Steps (or Stages) applied in order. Depending on the applications, some of the steps may be omitted. FIG. 56 shows the processing steps of the Pipeline, in accordance with one embodiment. Said steps may include:

### Step 20: Conversion

During this step, the initial document is converted into HTML format. If the document is already in HTML format, this step is omitted.

### Step 22: Cleanup

During this step, the HTML is simplified substantially. Tables may be cleaned up by minimizing empty cells, CSS styles could be consolidated or completely removed if they are not relevant to the domain, HTML node attributes could be converted to CSS or completely removed, etc. The cleanup step 20 preserves the content, but can substantially rework the underlying HTML source code in order to achieve equivalent rendering with a much cleaner HTML structure, in one embodiment. The purpose of the cleanup step 20 is to provide a solid foundation for further stages, simplifying the initial input as much as possible. In one embodiment, application domain or the type of documents being processed may dictate the processing blocks associated with the cleanup step 560.

### Step 24: Fragmentation

This step takes the document and slices it into Fragments. Each Fragment may be a single paragraph, a single table, a single image, or a single horizontal HTML line. The purpose of the step 24 is to then give bite-sized chunks to the Featurization and Classification stages, which are described below. Both the Featurization and the Classification stages operate on individual fragments.

### Step 26: Featurization

During this step, each Fragment is assigned a set of Features. Features may be, but are not limited to:

Formatting features: In one embodiment, formatting features are answers to the following questions:

Is the entire paragraph bold? Does it contain bolded text? Does it contain italicized text? What is the paragraph's text alignment? What is its font size? What is its font?

Semantic features: In one embodiment, formatting features are answers to the following questions: Does the paragraph resemble boilerplate text? Does it resemble a section title? Does it resemble a table of contents? Does it resemble a page number? If it is a table, does it resemble a particular table type (e.g. an Income Statement or a Balance Sheet in the domain of company financial information)?

Miscellaneous features relevant to the domain: In one embodiment, Miscellaneous features tare answers to the following questions: closeness to a table of contents, closeness to a page break, length of text, number of sentences, etc.

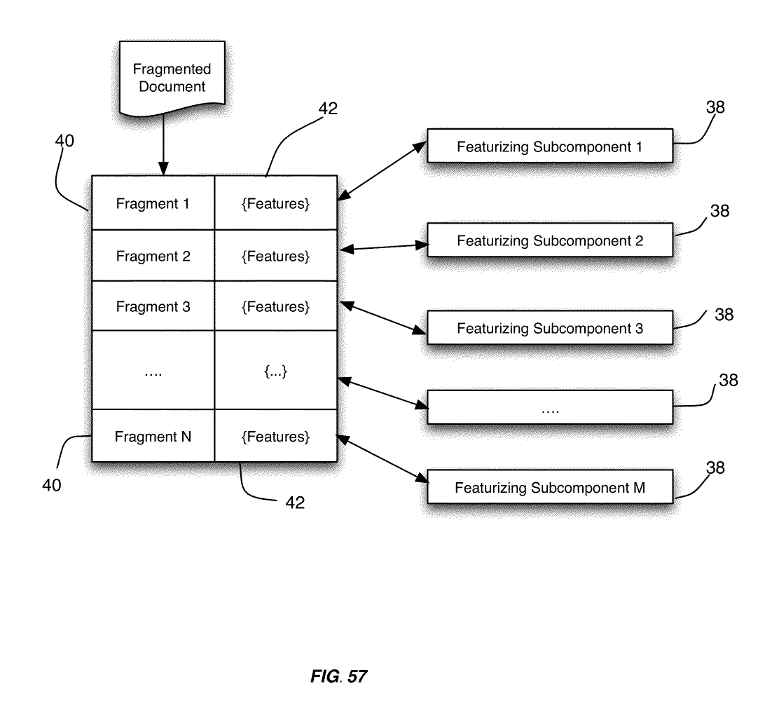

As illustrated on FIG. 57, the featurization step 26 utilizes one or more featurizing subcomponents 38 configured to run in sequence. Each featurizing subcomponent 38 is responsible for assigning one or more features 42 to each fragment 40. The fact that the featurizing subcomponents 38 are run in sequence allows for defining dependencies—one featurizing subcomponent 38 may use the output of a previous featurizing subcomponent 38.

### Step 28: Classification

In this stage, various techniques including machine learning, greedy algorithms, dynamic programming, and others are used to classify each fragment into several classes. Classes are domain-specific, but can be things like: A top-level title, a subtitle, a financial table, a table of contents, boilerplate text that needs to be deleted, etc. Each Fragment can belong to multiple classes, which we will call Tags. The purpose of this step is to provide both structural and semantic information to a repackaging stage 30, which can then reorder, remove, reformat, and manipulate in any other way the document based on the tags identified by the classification stage.

### Step 30: Repackaging

This step takes the Fragments and their Tags, and compiles a document package 36 that another system (e.g. the Document Reader 12) can understand and display. This stage acts like an integration point with any external system (or set of external systems) that could be dependent on the Pipeline.

In one embodiment, a document 34 is not the only input of the Pipeline. Each step can read and write additional metadata information (including intermediate progress and results) to separate files, databases, or external systems.

In one embodiment, pipelines may be used for other applications in addition to preparing documents for the Document Reader 12. Some of the most important applications are described below:

### Document Scoring

In this application, a series of Document Scores are calculated and assigned to each unstructured document. In one embodiment, to produce Document Scores the following calculation may be performed in a pipeline:
1) Computing sentiment (is the document positive or negative overall?). The sentiment of a document is referred to herein as “Document Sentiment”
2) Calculating litigation risk score (how frequently are words such as “subpoena”, “litigation”, “lawsuit”, etc. mentioned in the document?)
3) Scoring differences (how different is a document from a previous version of the same document?)
4) Identifying document keywords and key phrases (what are the most frequently mentioned keywords or phrases in this document, that are otherwise infrequently mentioned in a set of documents)
5) Finding frequency of occurrence of certain keywords in a document
6) Finding documents of disproportional characteristics among a set of documents
   Preparing Documents with Tables:

Another application is preparing documents with tables for substantially better export to Excel. Typically, copying and then pasting tables from documents on the Web into Excel is a very difficult task—most tables do not look good once pasted in Excel. Using a pipeline, these tables can be cleaned up in the cleanup stage 22 and be much better when pasted into Excel.

In all of the above, a document may go through some (not necessarily all) of the steps of conversion 20, cleanup 22, fragmentation 24, featurization 26, classification 28, and repackaging 30. For example, to compute Document Sentiment, once the document has been classified, during the repackaging stage 30 the words within the document can be compared against a Sentiment Dictionary to assign an overall score to the Document. Thus, an output of the repackaging stage 30 may include the Document Sentiment for this document.

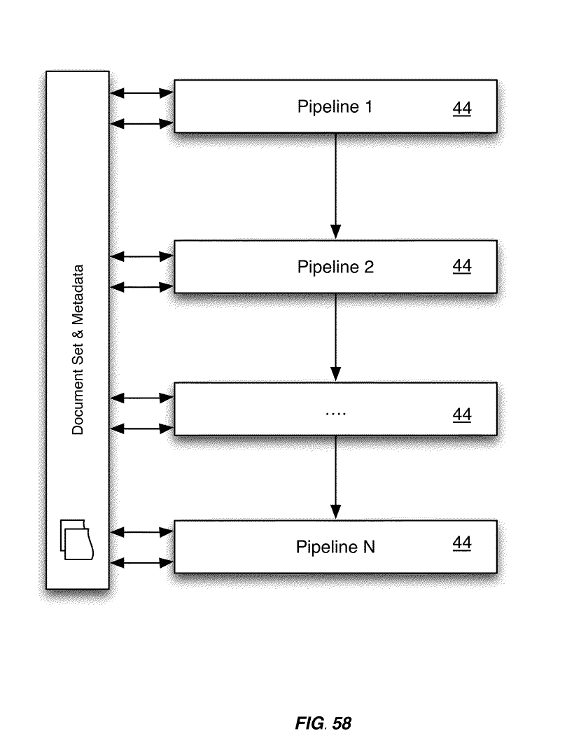

In one embodiment, a document may be processing using a Pipeline Sequence comprising a plurality of individual pipelines 44 (see FIG. 58), each for a specific application. In the Pipeline Sequence multiple pipelines are executed sequentially, each pipeline using some or all of the outputs of the previous one.

The Pipeline Sequence is useful whenever a multi-pipeline problem such as comparing a single document to a set of documents exists. In such scenarios, the first Pipeline processes each document and outputs the resulting calculations to a common repository (e.g. file, database, external system), which aggregates the results. Then, the second pipeline processes each document in order and compares the calculations for the individual document to the consolidated score. This approach is very useful when trying to identify documents that are outliers based on some kind of Document Score.

The Pipeline and the Pipeline Sequence are both methods that may be used for many other problems outside the field of textual documents.

### Document Search

The Document Search Component C16 allows the user to search and find documents of interests more quickly than traditional tools. It requires fewer user interactions to get to the document of interest. This is achieved by a powerful search capability that is able to recognize complex queries and return results in a faster, more streamlined user interface.

In one embodiment, the Document Search Component C16 may generate the following User Interface (UI) elements:

1) Search Box: This is where the user enters text. The text entered in a Search Box is called a Search Query.
2) Live Search Results Area: This is where the search results are shown. The word “Live” is used to illustrate that the Live Search Results Area is updated on every user keystroke. Pressing the “Enter” key is not needed for the Live Search Results Area to be updated. The Live Search Results Area may include multiple Matching Entities. Each Matching Entity has one or multiple Matching Documents associated with it.

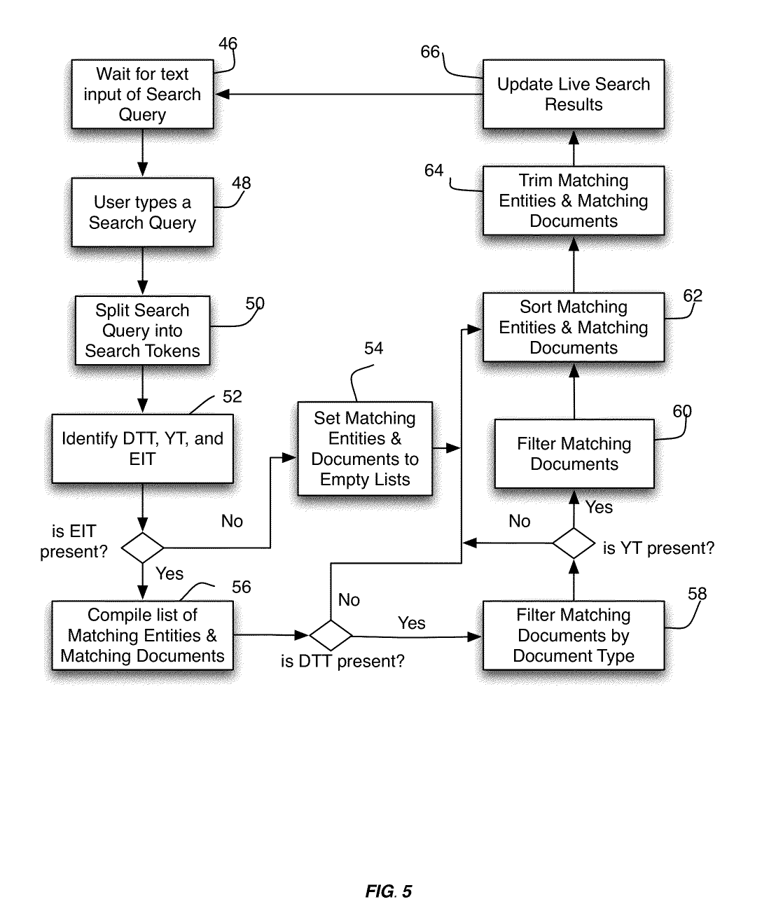

In one embodiment, the Document Search Component C16 may execute a search process as illustrated in FIG. 5. Referring to FIG. 5, at block 46 the Document Search Component C16 waits for the user to enter a Search Query into the Search Box. At block 48, the user enters a Search Query. As soon as a Search Query is entered, all “space” symbols (“ ”) are identified, and the Search Query is broken down into Search Tokens at block 50, each token containing no spaces. If a Search Token matches one of the Document Types recognized by the system, then this token is called the Document Type Token (DTT). If a Search Token matches a valid calendar year (e.g. 1995, 2004, 2013, etc.), it is called the Year Token (YT). All other tokens are concatenated together using the space symbol, and the combined new token will be called the Entity Identifier Token (EIT). At block 52, the tokens are identified.

In one embodiment, if no Entity Identifier Token is recognized, the search returns no results at block 54. If a valid Entity Identifier Token (EIT) is recognized then all Entities are filtered to leave only Entities matching the EIT at block 56. Depending on the area of application, “matching” will be defined differently. For example, in the domain of SEC Filings, an Entity is a Public US Company, and an Entity matches the EIT if the name or the stock ticker symbol of the public company contains the EIT. The entities matching the EIT will be called Matching Entities. All documents associated with each Matching Entity are going to be referred to as “Matching Documents” for that Entity.

If a valid Document Type Token (DTT) is identified, then the Matching Documents for each Matching Entity are then further filtered to remove any Documents not matching the DTT at block 58. Matching may be performed based on the following matching condition: if the DTT equals the type of the Matching Document, then the Matching Document is preserved. Otherwise, it is not preserved.

Finally, if a valid Year Token (YT) is identified, then the Matching Documents for each Matching Entity are then further filtered to remove any Documents not matching the YT at block 60. A document matches the YT if the associated publishing year for that document equals the YT.

After these steps, a series of Matching Entities along with their Matching Documents remain. At block 62 the Matching Entities are sorted. This is domain-specific and may work differently depending on the application domain. In the domain of SEC Filings, one valid way to sort the Matching Companies is alphabetically, another one is by market capitalization (the current value of the company on the public stock exchange), and a third one is by matching relevancy. These are just examples, there may be many other ways to sort the resulting Matching Entities.

At block 64 Matching Entities and Matching Documents are trimmed. As the results of the Search will be passed down to the UI, it is possible that the UI will not be able to properly display hundreds or thousands of search results, as they will not fit on a computer screen. Thus, the Matching Entities and/or Matching Documents could be trimmed. One example in the domain of SEC Filings may be to leave 3 Matching Companies and one Matching Document per company.

The sorting block 522 and the trimming block 522 are optional, in some embodiments. At block 66, the live search results are updated.

Looking at a concrete example from the domain of SEC Filings, “Entities” are publicly-traded US companies, and “Documents” are their SEC Filings: Annual Reports (their Document Type is 10-K), Quarterly Reports (Document Type=10-Q), Events (Document Type=8-K), and many others.

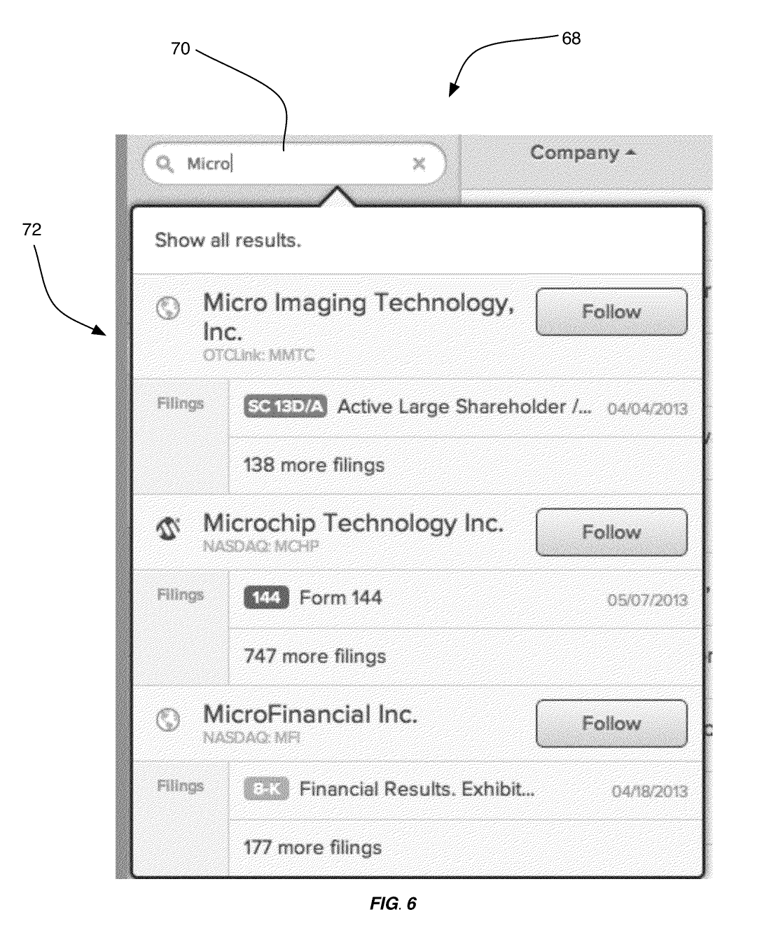

FIG. 6 shows a Search UI 68 generated by the Document Search Component C16, in accordance with one embodiment. First, the user types a Search Query, e.g. “Micro” into a Search Box 70.

1) The Document Type Token is not identified, and thus DTT=empty
2) The Year Token is not identified, and thus YT=empty
3) The Entity Identifier Token is found, and it is “Micro”.

The Live Search Results Area 72 pops up and shows the Matching Companies, along with the Matching Documents for each Matching Company.

The Live Search Results Area 72 may include action areas that link to a Search Results page: the “Show all results” and the “NNN more filings” elements in the graphic. Some supplemental information can be displayed for each Matching Entity and each Matching Document, e.g. company ticker symbol and stock exchange, and document creation date.

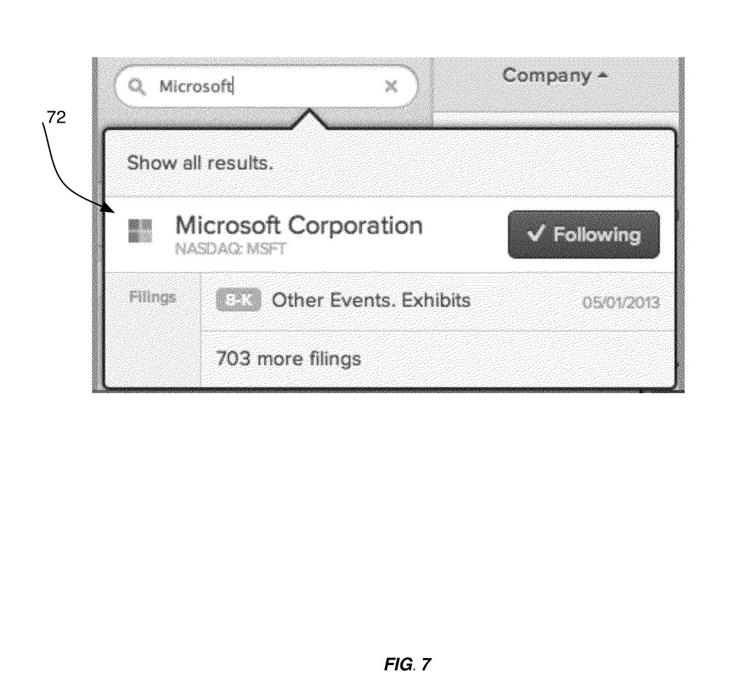

FIG. 7 shows a state of the UI where the user has now typed in the Search Query “Microsoft”. This time:

1) DTT=empty
2) YT=empty

### 3) EIT=“Microsoft”

As indicated, the Live Search Results area now contains only one result (because the database has only one matching company).

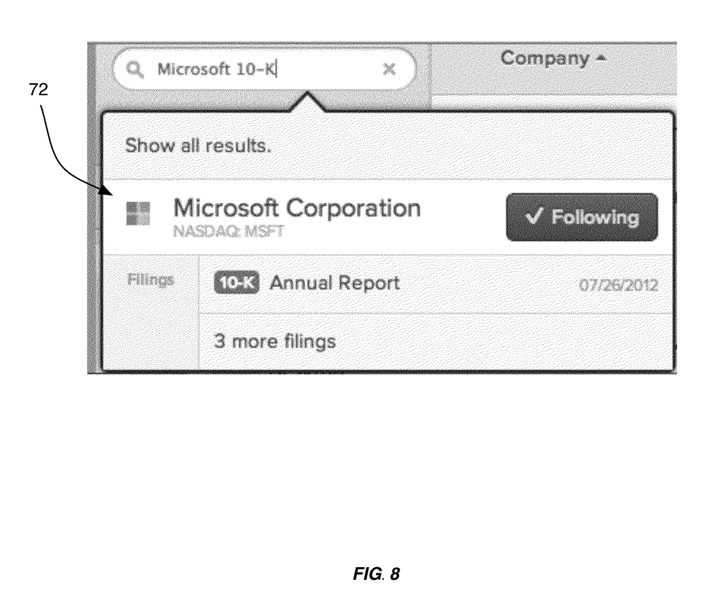

In FIG. 8, the user has narrowed down what they are searching for even further and have typed in the Search Query “Microsoft 10-K”. Now:

### 1) DTT=“10-K”

2) YT=empty

### 3) EIT=“Microsoft”

The number of search results immediately drops down from 703 to 3, because the database contains only 3 documents of the type “10-K” for “Microsoft”. The document shown for Microsoft is also its latest 10-K report.

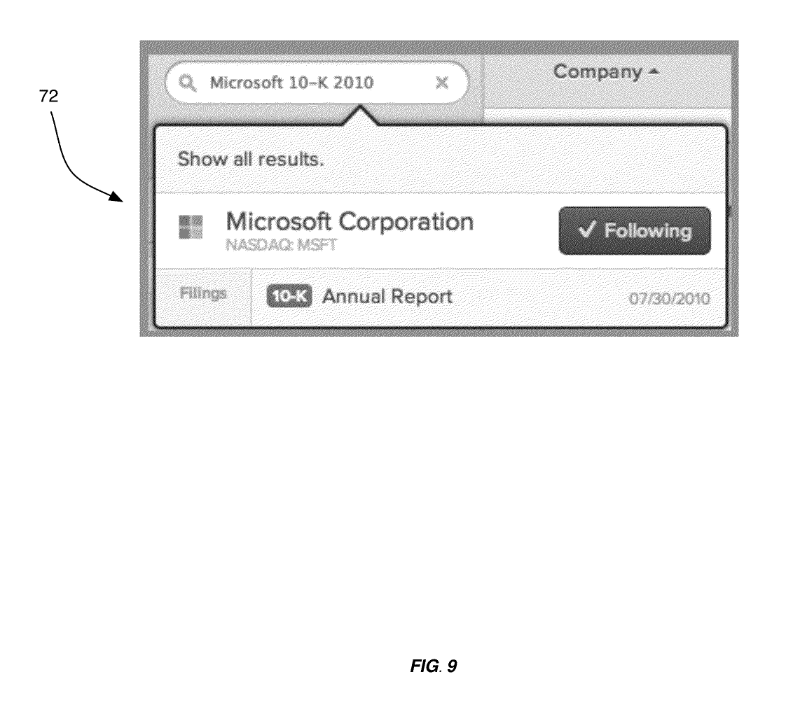

In FIG. 9, the user has further narrowed down their Search Query by also including a year: “Microsoft 10-K 2010”.

### 1) DTT=“10-K”

### 2) YT=“2010”

### 3) EIT=“Microsoft”

The number of search results drops down to a single document, and that one document is shown in the Live Search Results area. The user can thus very quickly jump directly to the document they were searching for.

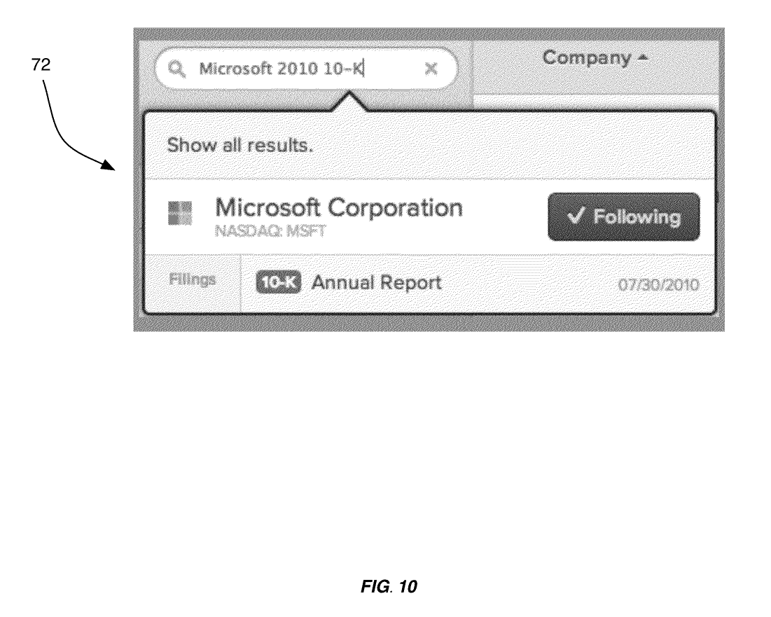

FIG. 10 shows that the order of the search terms is not important. The user could type “Microsoft 2010 10-K” or in fact any other order of the 3 words “Microsoft”, “2010” and “10-K”, and the search results would still be the same.

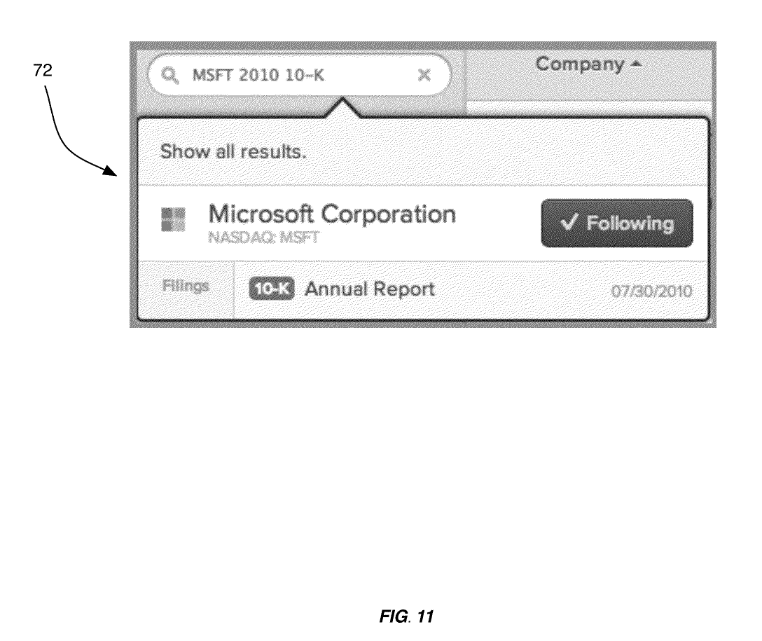

FIG. 11 shows that the user can search not only by a company name, but also by a company ticker symbol. In this example, the user has typed in the Search Query “MSFT 2010 10-K”, instead of “Microsoft 2010 10-K”.

### 1) DTT=“10-K”

### 2) YT=“2010”

### 3) EIT=“MSFT”

Again, there is only one search result displayed and the user can quickly jump to it.

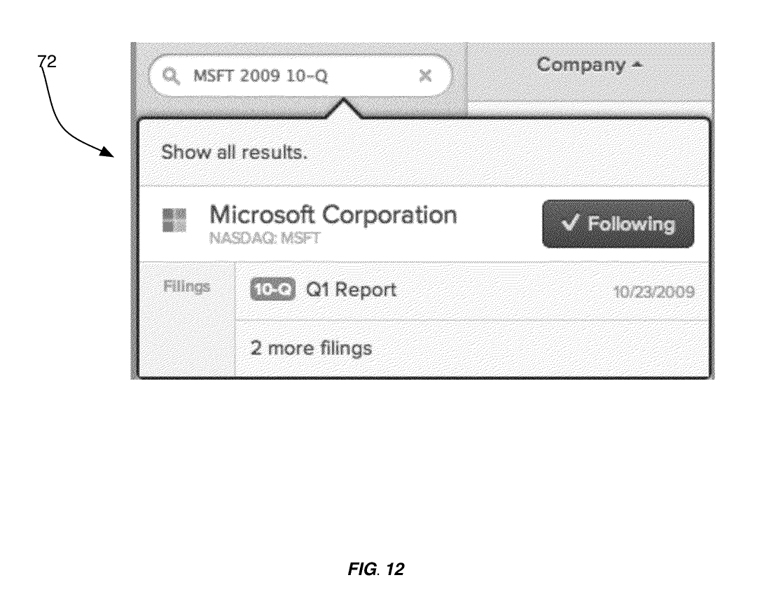

FIG. 12 shows an example where the year and the document type are different. The live search results are now has only Quarterly Reports (10-Q), and shows that it has found a total of 3 results—three quarterly reports for Microsoft for 2009.

### 1) DTT=“10-Q”

### 2) YT=“2009”

### 3) EIT=“MSFT”

### Document Selection

The Document Selection Component C2 allows the user to select which document to open. In one embodiment, the Document Selection Component C2 may generate both a traditional user interface in the form of a table with all documents, and also a much more streamlined and convenient user interface that significantly speeds up the access to the most important documents (hereinafter referred to as the “Timeline View”). The Timeline View enables users to very quickly find documents published annually, quarterly, as well as the ones published the most recently. In certain domains (e.g. SEC Filings), these are by far the most important documents. The Timeline View thus shortens substantially the time it takes to get to the relevant documents.

The Document Selection Component C2 may comprise three elements:

1) List View, which shows documents in the traditional and currently ubiquitous table form. In the List View, each row represents a document, and each column represents relevant document properties (type, year published, etc.):
2) Timeline View, which shows a substantially more convenient and usable way to
3) View Toggle, which allows the user to switch between the Timeline View and the List View.

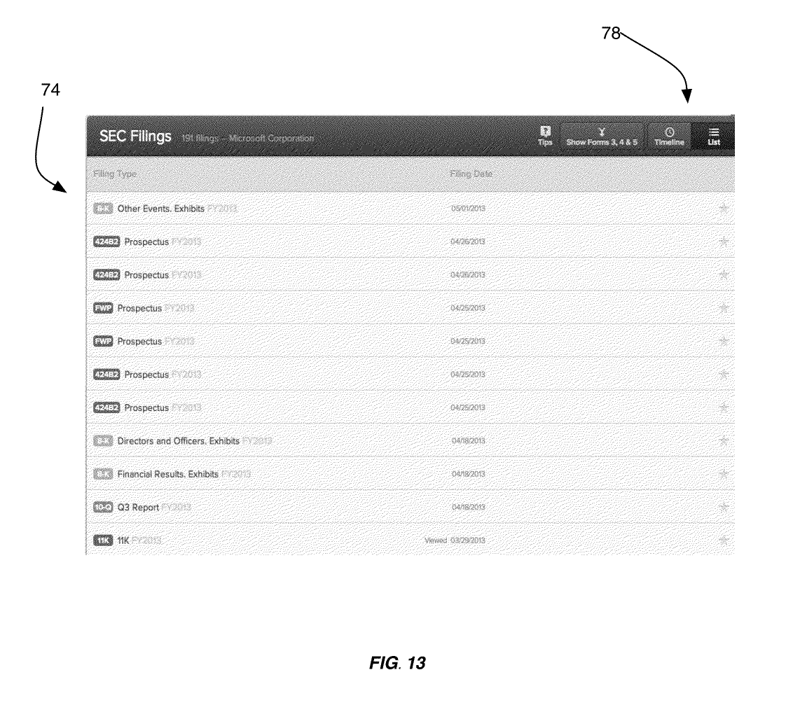

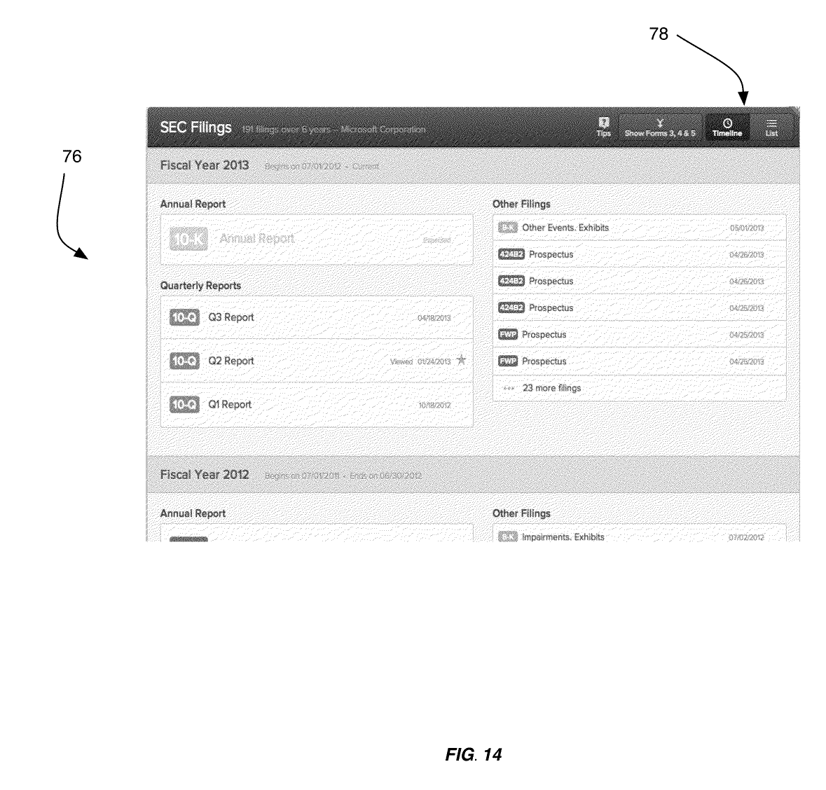

FIG. 13 shows an embodiment of a UI generated by the Document Selection Component C2 comprising a List View 74, whereas FIG. 14 shows a Timeline View 76 of the UI. A View Toggle element 78 located at the top right of the UI includes a two buttons to toggle between the List View 130 and the Timeline View 76.

As will be seen, the Timeline view 76 comprises vertically stacked Yearly Blocks. Each Yearly Block has three elements:

1) The Annual Area, which contains any documents submitted on an annual schedule
2) The Quarterly Area, which contains any documents submitted on a quarterly schedule
The Annual and Quarterly areas are stacked vertically in the left half of the screen.
3) The Other Areas, which contains any documents submitted on an occasional/unpredictable schedule. The Others Area takes up the right half of the screen.

Each of the three areas (Annual, Quarterly, Others) contains one Document Block per document. Each Document Block has the following elements:

1) A Graphical Icon representing the document type

### 2) A Document Title.

3) A Publishing Date, showing the exact date when the document was published.

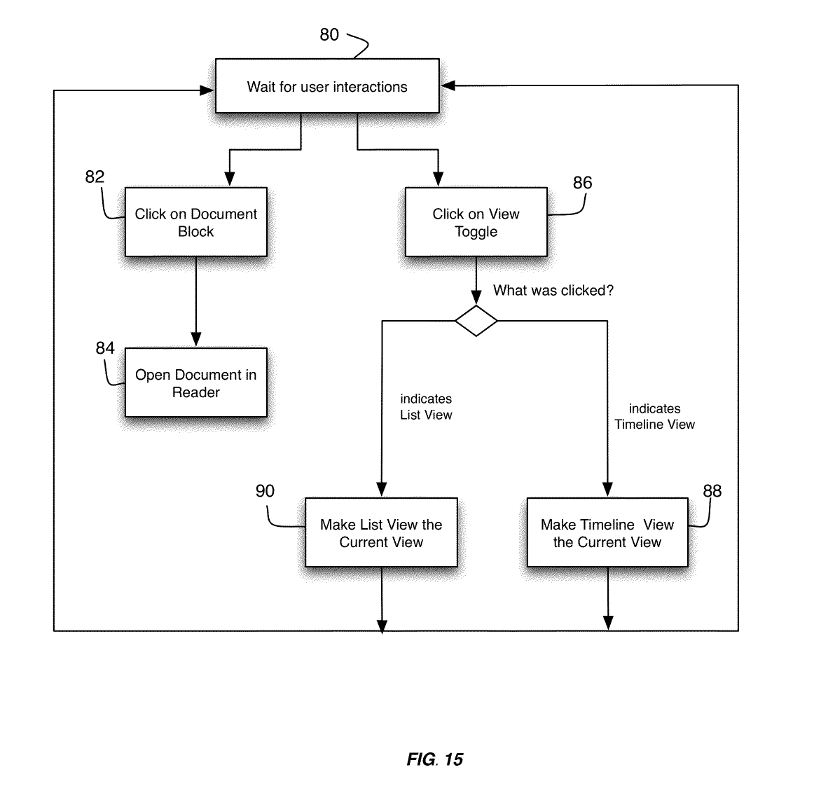

FIG. 15 shows the User interactions that the Document Selection Component C2 may support, in accordance with one embodiment of the invention. Referring to FIG. 15, the component C2 waits for user input/interactions at block 80. Clicking (block 82) on any Document Block opens the document at block 84. Both the List View and the Timeline View can be scrolled up and down, like any traditional page that is longer than one computer screen. At block 86 user-input corresponding to the View Toggle is captured.

If a “Timeline” button on the View Toggle is clicked then the view switches to Timeline View at block 88. If the current view is already the Timeline View, nothing happens upon clicking the Timeline button. If the user clicks on s “List” button of the View Toggle then the current view switches to List View at block 90. If the current view is already the List View, nothing happens upon clicking the List button.

### Document Filtering

In one embodiment, the Document Filtering Component C17 works in conjunction with the List View of the Document Selection Component C2. Without filtering, the List View can contain too many documents and it may be difficult for the user to find the one she is looking for. The Document Filtering Component C17 may use pre-defined filters such as “Year range”, “Company”, “Document types”. These parameters are selected through components such as check boxes, radio buttons, drop downs, and visual components suitable for selecting the filter.

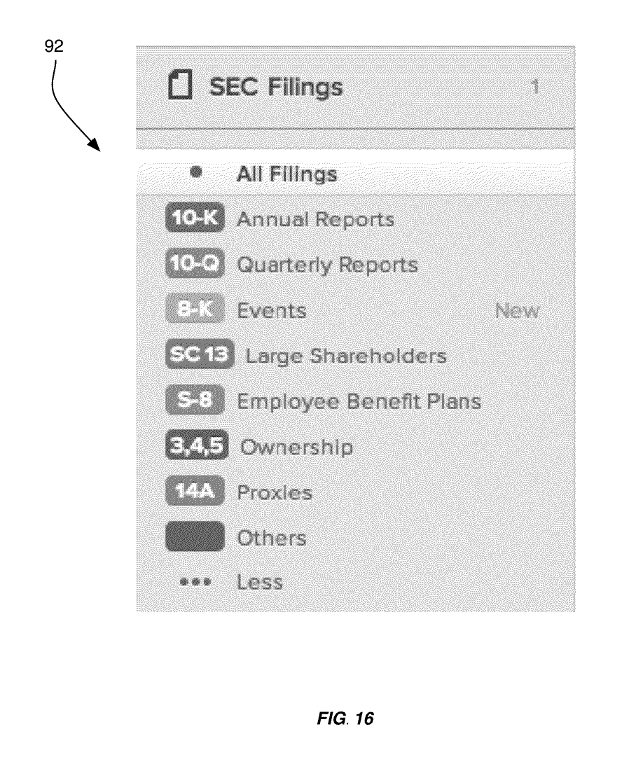

FIG. 16 illustrates a very simple filtering UI 92, which allows the user to filter by Document Type. The filtering UI 92 also shows how many new (recent and unread) documents exist in the database for a given document type.

In one embodiment, the Document Filtering Component C17 may comprise the following:

1) Vertically stacked Filtering Options
2) One of the Filtering Options is an Active Filtering Option. It has a different visual style from the other Filtering Options to for easy distinction.
3) A More/Less Toggle which allows the Document Filtering Component to take more/less visual space by hiding a subset of the Filtering Options.

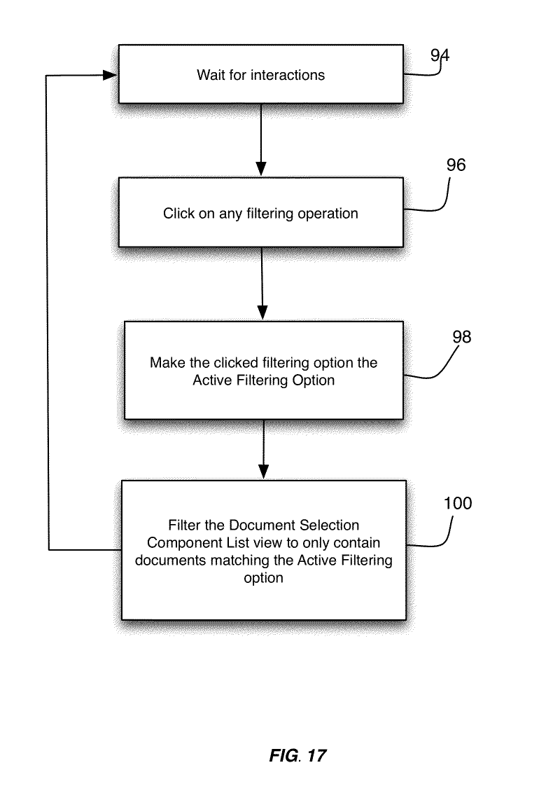

FIG. 17 shows a workflow for the Document Filtering Component C17, in accordance with one embodiment.

Referring to FIG. 17, Initially, at block 94, the component C17 waits for user-input or interactions. At block 96, the user selects one of the Filter Options. At block 98, the selected Filter Option is marked as Active. The User can then use the mouse to click on any of the other Filter(ing) Options. Each selection of a Filtering Option causes that option to be marked as Active. At block 100, the List View is filtered to only contain documents matching the selected Filtering Option.

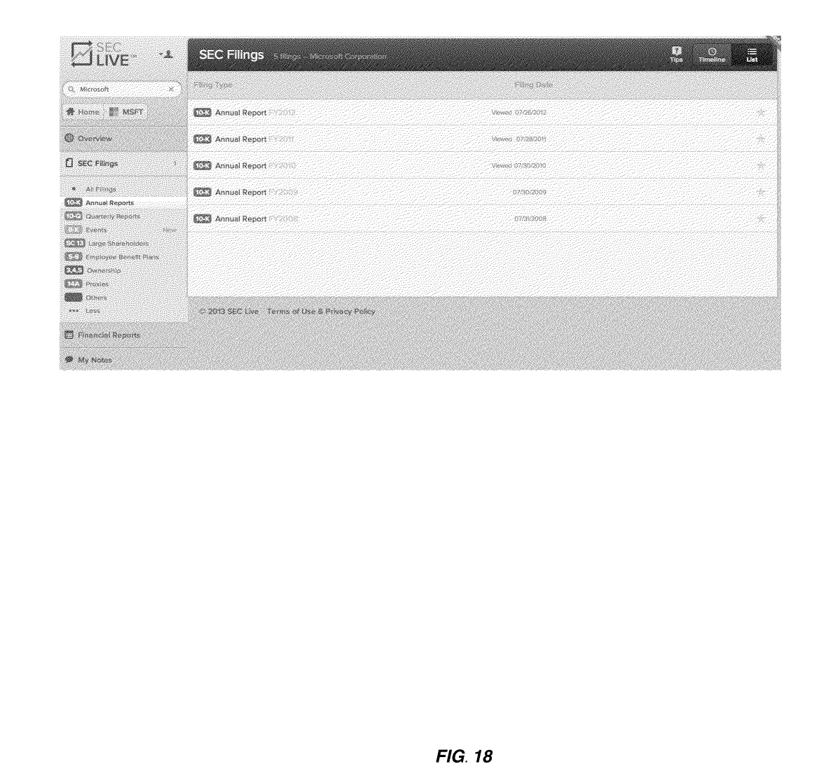

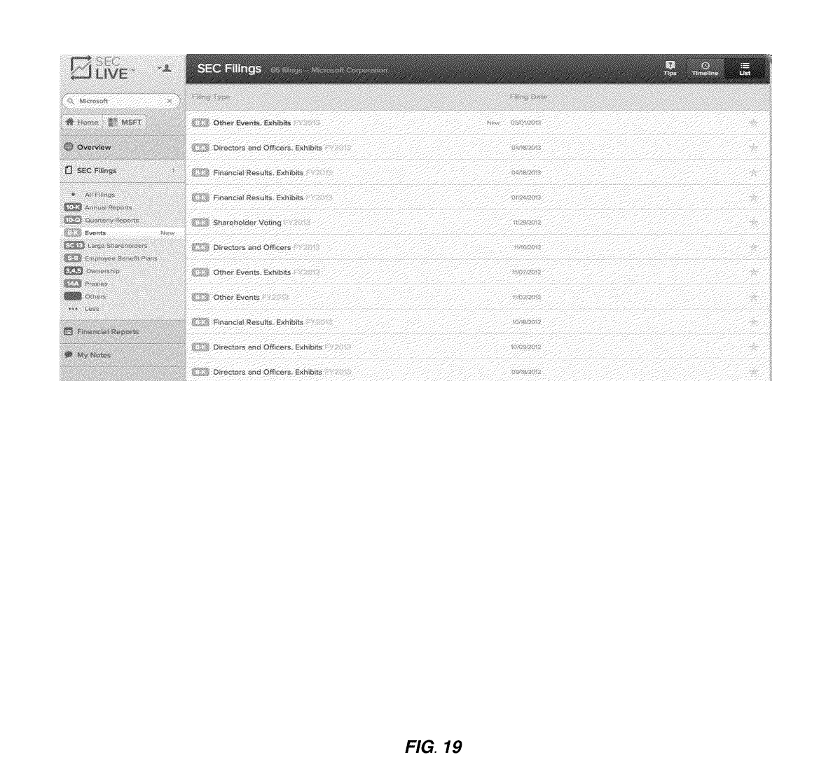

FIG. 18 and FIG. 19 illustrate how the Filtering by Document Type works. Both show a list of documents (already filtered by a Company) now further filtered by Document Type. More particularly, FIG. 18 shows the document list filtered by Document Type=10-K (Annual Report), whereas FIG. 19 shows the document list filtered by Document Type=8-K (Events).

### Document Viewing

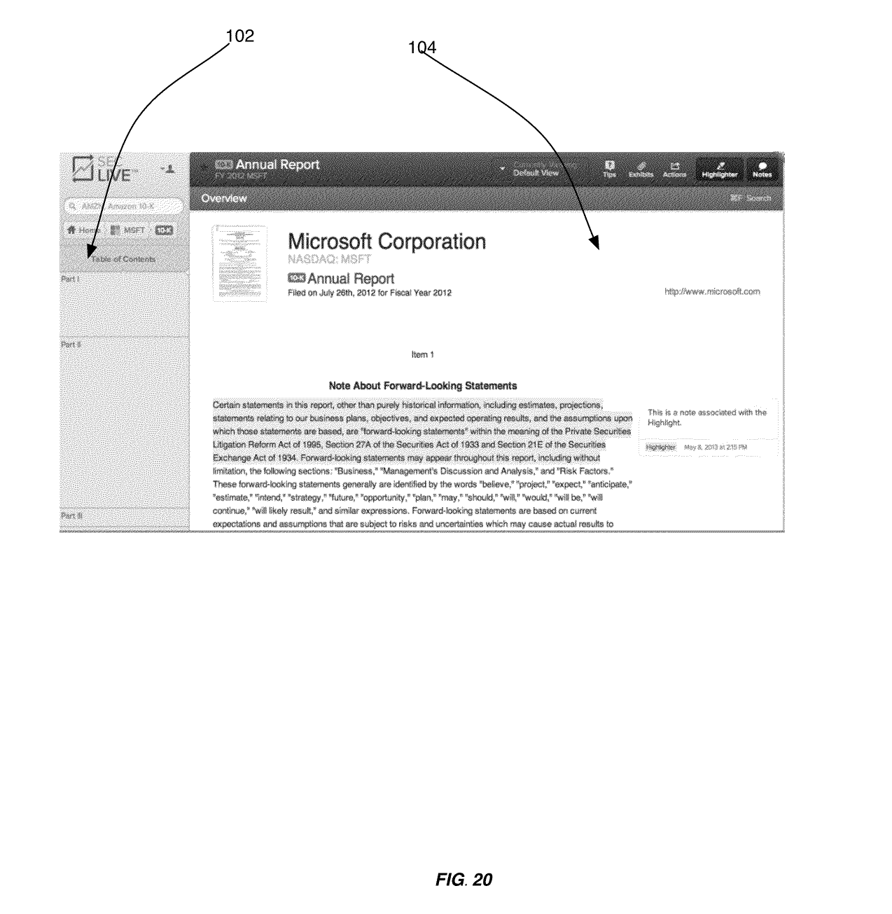

Selecting a document from the Search Component C16 or the Selection Component C2 generates a document viewing UI. One embodiment of the document viewing UI is shown in FIG. 20. As will be seen, the document viewing UI includes a Navigation UI Component 102 and a Document Viewing UI Component 104. These components allow the user to read the document, to quickly and efficiently navigate among its sections, to create highlights and notes, and many other actions listed below.

### Document Navigation

When the user opens a document, he or she can use the Navigation UI Component 102 to quickly and efficiently navigate through the document. In one embodiment, the Navigation UI Component 102 may include at a glance all sections in the document, as well as any annotations, highlights, or important The objects within these sections. Using the Navigation UI Component 102, the user can dive into specific sections and/or immediately jump to the objects of interest.

The core benefit of the Navigation UI Component 102 is that it allows the user to very quickly see all important items within the document—section titles, their relative size, annotations created in the document and their location, the current location within the document, and important objects. Interacting with the Navigation Component allows for quick and efficient navigation between the sections and the important objects within the document.

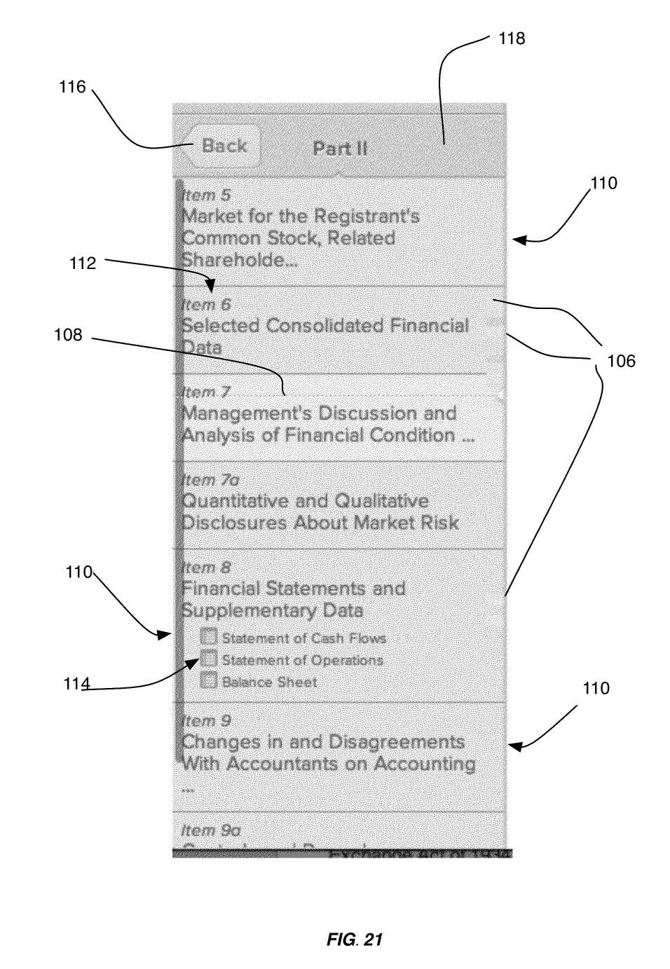

FIG. 21 shows an exemplary Navigation UI Component 102, in accordance with one embodiment of the invention. The Navigation UI Component 102 includes Annotation markers 106: Each marker 106 represents an annotation created within the Document Viewing UI Component 104. The markers are the same semantic style as the document annotations, positioned at the same location as the annotation in the document, and proportionally sized. A Location indicator 108 indicates the current position of the portion of the document being viewed in the Document Viewing UI Component. In one embodiment, the location indicator 108 may be dragged using a mouse. It also automatically changes its location based on where the user is within the Document Viewing UI Component.

The Navigation UI Component 102 may also include a plurality of Section Blocks 110, each being relatively sized (although not necessarily proportionally) to the other section blocks at its level. Each section block 110 may include a Section Title 112, matching the title of the section. Each Section Title 112 can include one or more Smart Objects 114, marking important objects nested within that section. In accordance with one embodiment, one and only one of the sections may be marked as “Active” (or “Current”). The Active section is shown in a different visual style to visually distinguish it from the non-active sections. The Location Indicator is always positioned somewhere within the Section Block representing the Active Section.

A Back Button 116 allows the user to go back up one level in the navigation and may only be shown if the current section has a parent section. A Parent Section Title 118 may only be shown if the current section has a parent section.

In one embodiment, the Navigation UI Component 102 supports the following user interactions:

### 1) Dragging the Location Indicator

Dragging the Location Indicator changes the Active Section. The Active Section is always the one over which the Location Indicator is positioned. Dragging the Location Indicator scrolls the Document Viewing Component to the exact same location shown by the Location Indicator on the Navigation.

### 2) Clicking one of the Inactive Section Blocks

The Location Indicator is scrolled to the top of the clicked Section. This makes the clicked section Active, and also scrolls the Document Viewing Component to the same location.
3) Clicking the Active Section Block. This action is referred to as “Isolation”.
The Document Viewing Component is updated to only show the contents of the Isolated Section.
The Navigation Component is updated to show the subsections of the Isolated Section.
The Location Indicator is scrolled to the very top of the first subsection of the Isolated Section. The first subsection becomes the Active Section.
The “Back” button is shown (if it was already visible, it just stays visible).
4) Clicking the Back button (if visible)
Undoes the last Isolation action, except that it preserves the Location Indicator's position.

### 5) Scrolling the Document Viewing Component

If the user scrolls the Document Viewing Component, the Navigation Component automatically updates to reflect the correct position for the Location Indicator, as well as the correct Active Section Block.

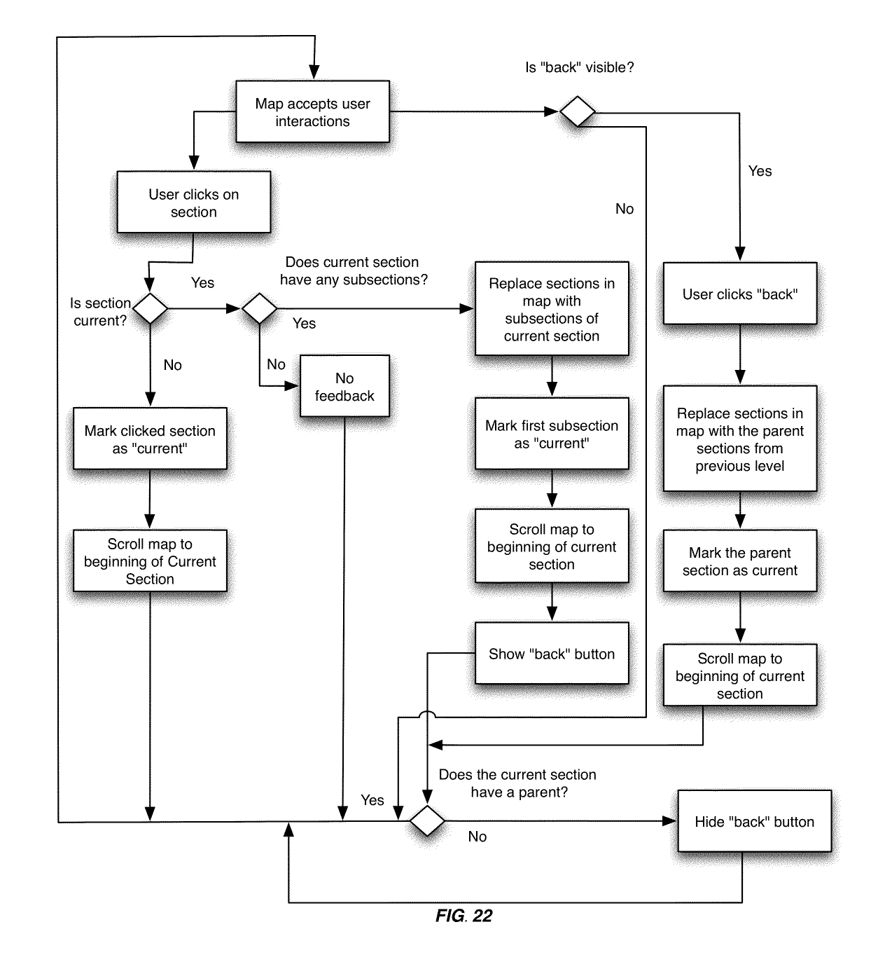

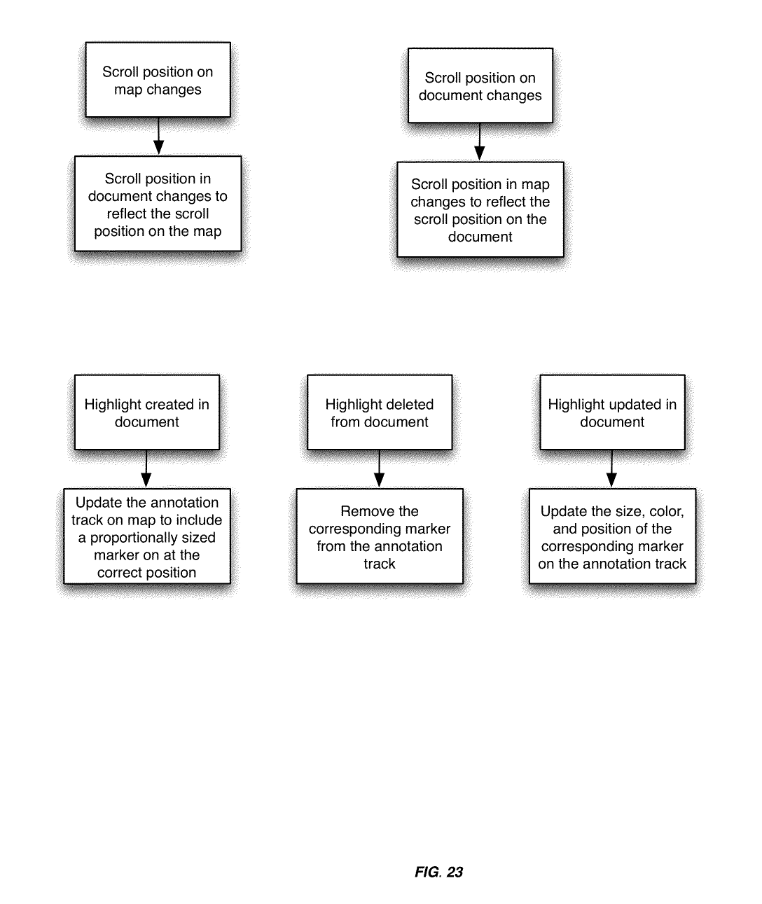

Interactions supported by the Navigation UI Component 102 are facilitated by backend Navigation Component C3 as will be expected. FIGS. 22-23 show exemplary workflows pertaining to navigation, in accordance with one embodiment of the invention. These processing reflected in these workflows are self explanatory in view of the above descriptions, and are thus not described further.

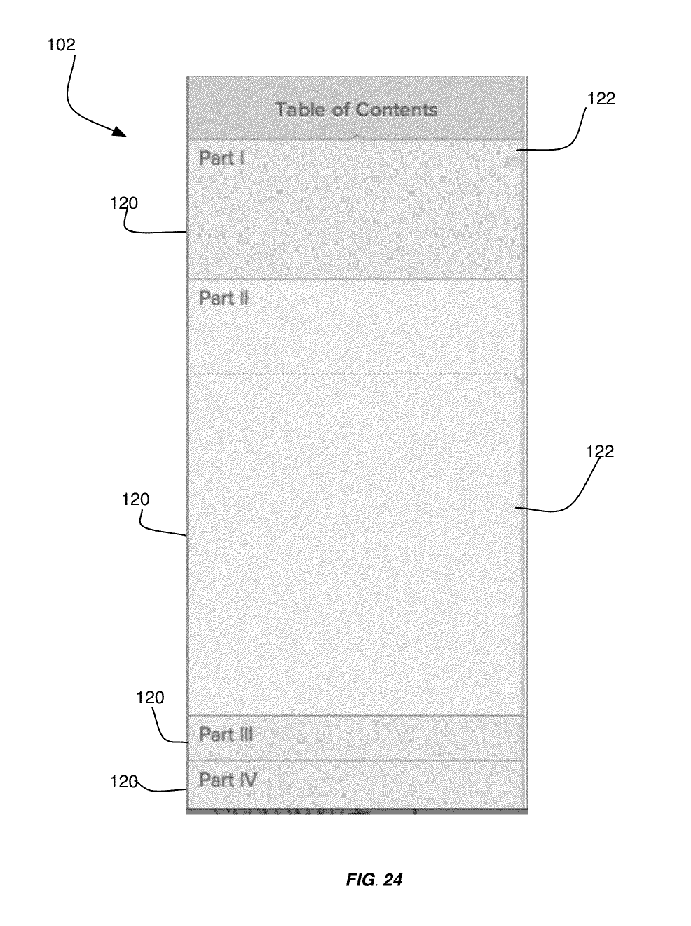

FIG. 24 shows a detailed view of the Navigation UI Component 102. As will be seen, the UI component 102 includes 4 top-level sections 120 named “Part I”, “Part II”, “Part III”, “Part IV”. The sections 120 are relatively sized the as follows: Part II is the largest, followed by Part I, and then finally Part IV and Part III. In FIG. 24, reference numeral 122 indicates annotations. In the particular example, the user has created 4 annotations 122 in the document: a green and a red one in “Part I”, and two yellow ones in “Part II”. The “Current” section is Part II. The user is roughly one quarter through reading Part II.

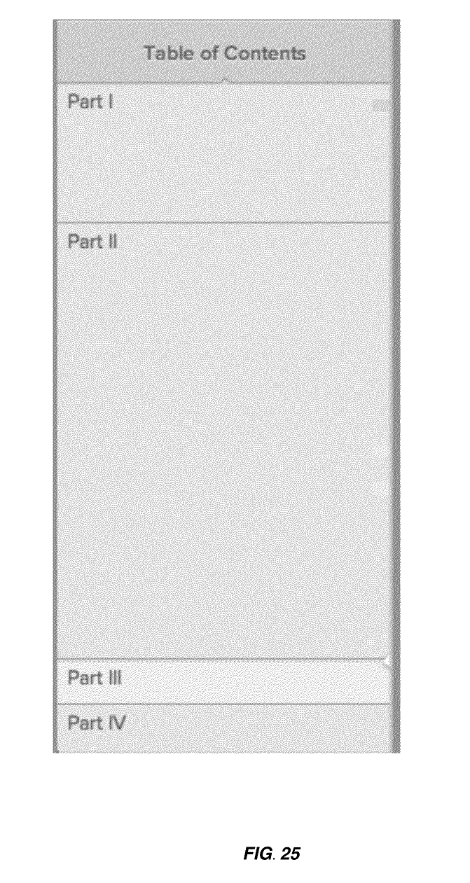

FIG. 25 shows a transition of the Navigation UI Component 102 after the user has now clicked on “Part III”. Note how Part III has changed its visual style, and the Location Indicator is positioned at the beginning of Part III.

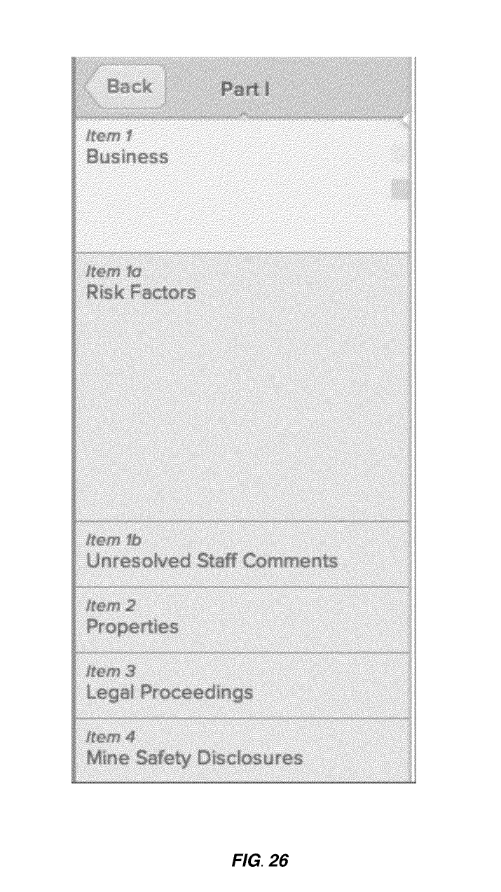

In FIG. 26 shows a transition of the Navigation UI Component 102 after the user has “Entered” (“Isolated”) Part I. Note how the navigation now contains six sections called “Item 1. Business”, “Item 1a. Risk Factors”, “Item 1b. Unresolved Staff Comments”, . . . , “Item 4. Mine Safety Disclosures”. Upon isolating Part I, the Location Indicator was scrolled to the top of Part I, the first section in Part I was marked as the current section, and the “Back” button appeared.

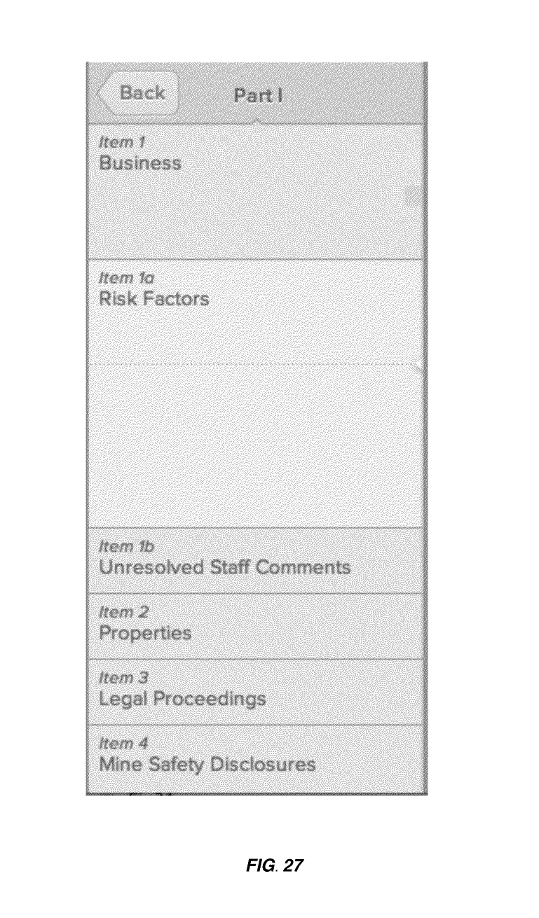

In FIG. 27 shows a transition of the Navigation UI Component 102 after the user has scrolled down to roughly one third of Item 1a. Note how Item 1a is marked as current, and the Location Indicator is roughly one third through Item 1a.

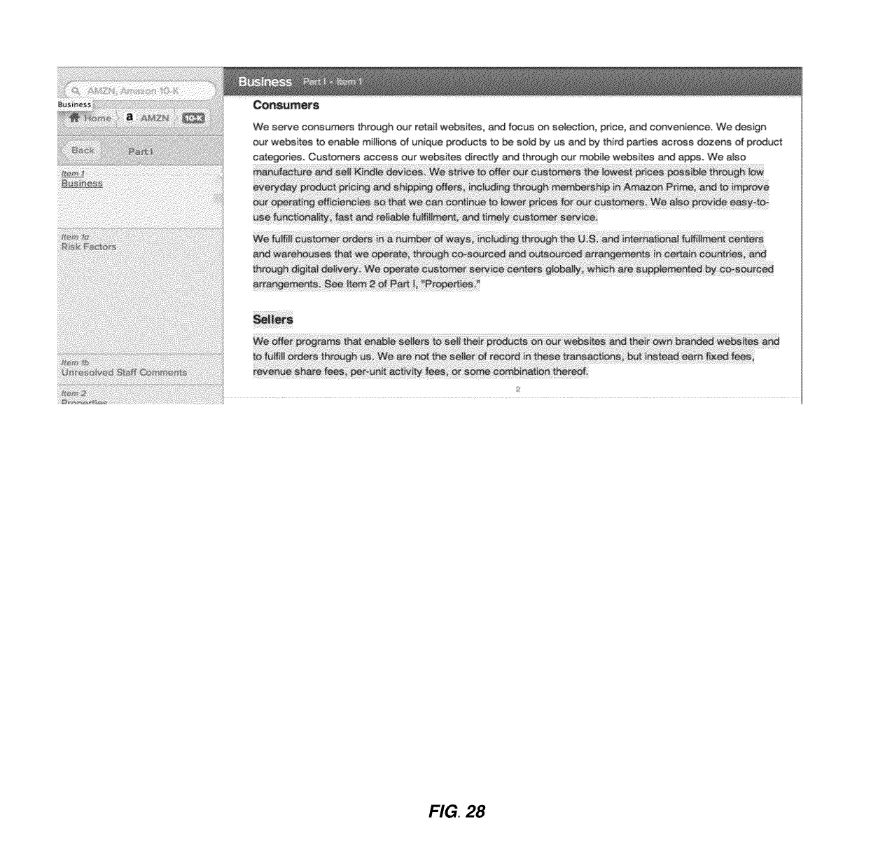

In FIG. 28 and example of Document Viewing Component where a user has made a green annotation or highlight. To correspond with the green annotation, the Location Indicator is roughly over the green Annotation Marker, and the Document Viewing Component is also scrolled roughly to the green highlight.

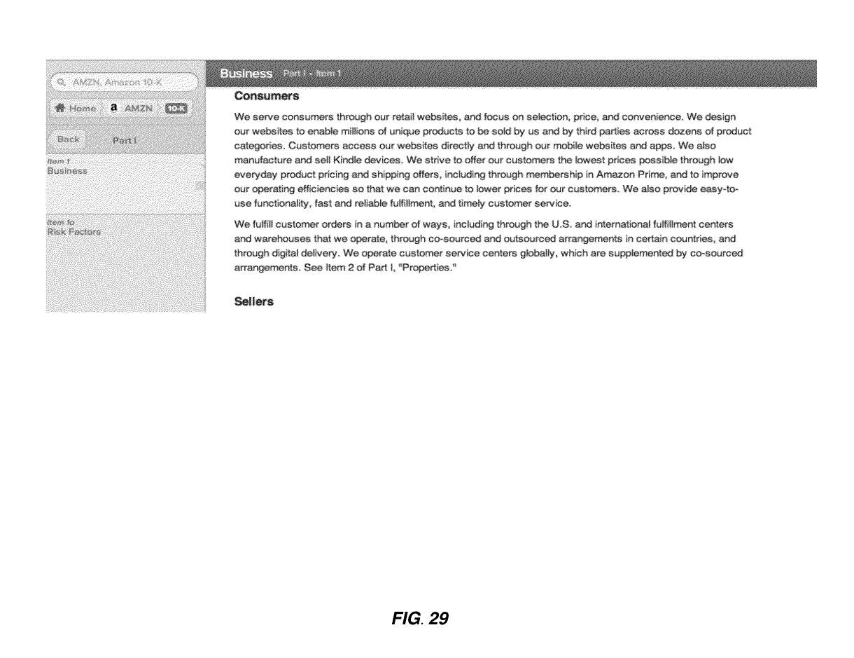

In FIG. 29, the user has deleted the green annotation. Responsive to said deletion, the Annotation Markers are instantly updated and the green marker is no longer visible.

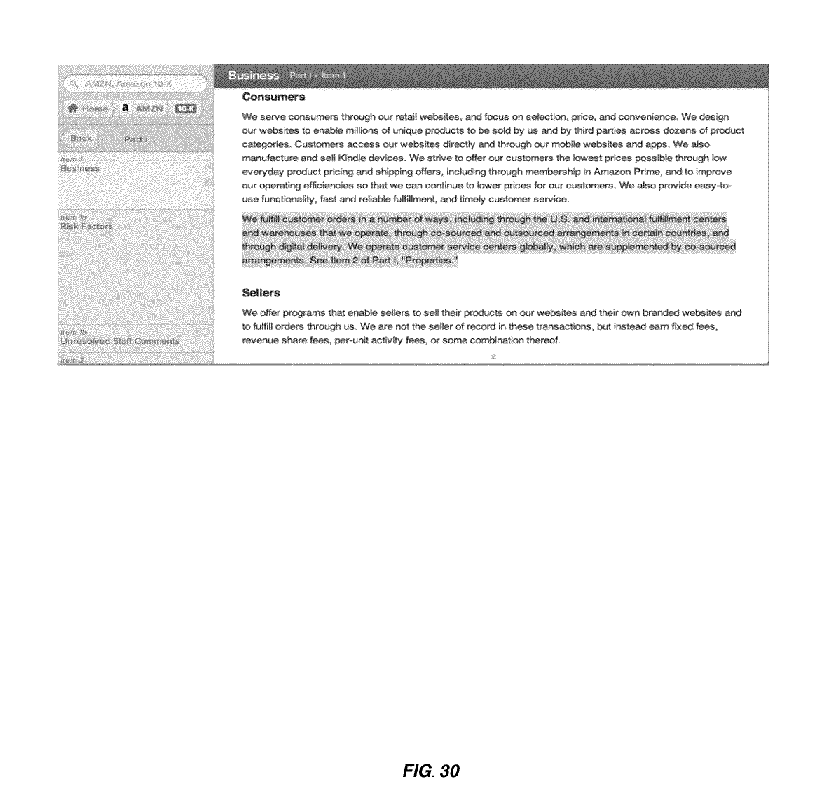

In FIG. 30, a new highlight was added. Note how the Annotation tracks immediately started showing the new Annotation Marker with the correct Semantic Color at the correct location.

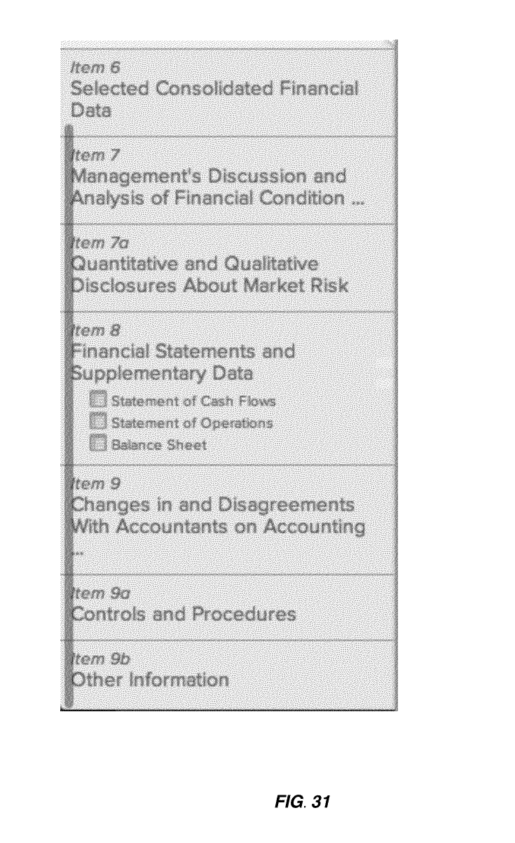

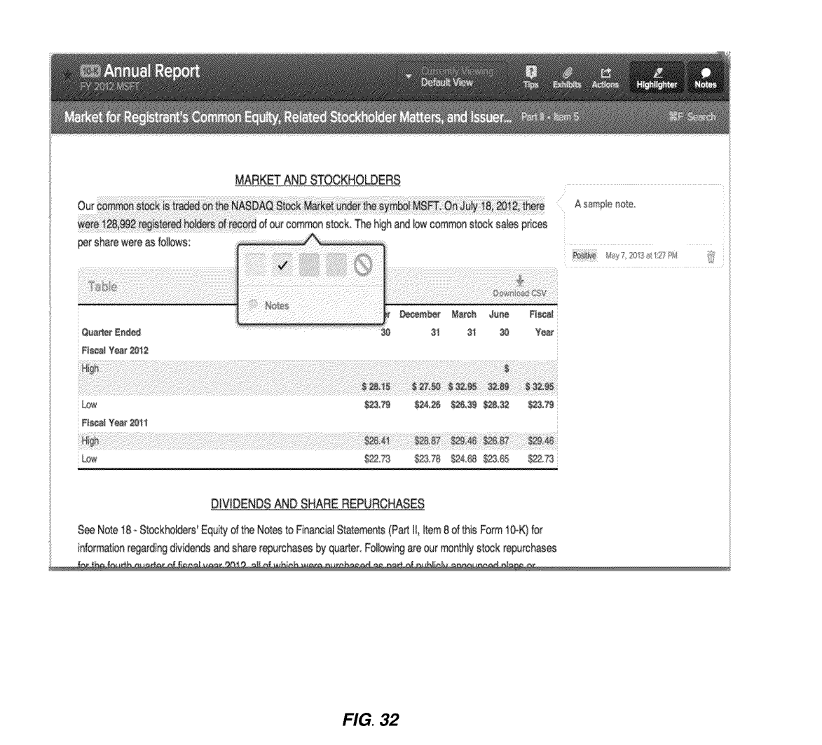

In FIG. 31, the user has “Isolated” Part II of the document. Note how the Navigation shows several important Smart Objects within Item 8. Those are three tables: “Statement of Cash Flows”, “Statement of Operations” and “Balance Sheet”. Clicking on the text or the icon of each one of these 3 Smart Objects would scroll the Navigation (and thus the Document Viewing Component) to the location where these objects start in the document.

### Document Viewing and Smart Actions

The Document Viewing Component C10 is the core component the user utilizes when reading documents. It lays out the contents of the section that is currently selected. The currently selected section can initially be the entire document, but the user can then later change that by using the Navigation Component. The Viewing Components is rich and may contain embedded Smart Actions Components.

The Document Viewing Component contains the following elements:

1) Text area: contains the contents of the document (text, tables, images, etc.). This highlights and Smart Actions Components are part of this area.
2) Notes area: a dedicated area to the right of the document that houses any notes created by the user. Each note is visually positioned next to the related highlighted text.
3) Highlights (see the Semantic Annotations Component): whenever the user makes a highlight, the background of the highlighted text changes to reflect what the user highlighted.
4) Notes (see the Semantic Annotations Component): they live in the notes area. Each note is associated with a single highlight.
5) Sticky Section Header: this element always stays fixed and visible, but its contents change based on what the current section being shown is.
6) Smart View Component: allows the user to change a different Smart View, as well as see what the currently selected smart view is.
7) Highlighter Toggle (see the Semantic Annotations Component): allows turning on/off the highlighter. When on, the cursor becomes a highlighter and any selected text gets a background indicating the highlight. When off, the mouse cursor acts like a normal mouse text selection cursor.

The Sticky Section Header functions as a reliable compass for knowing exactly where in the document you are. It is always there, and it shows the name of the current section that is being shown.

While scrolling the document, as the user passes through a header further up or further down in the document, the new header “sticks” to the top to always reflect the current section the user is looking at.

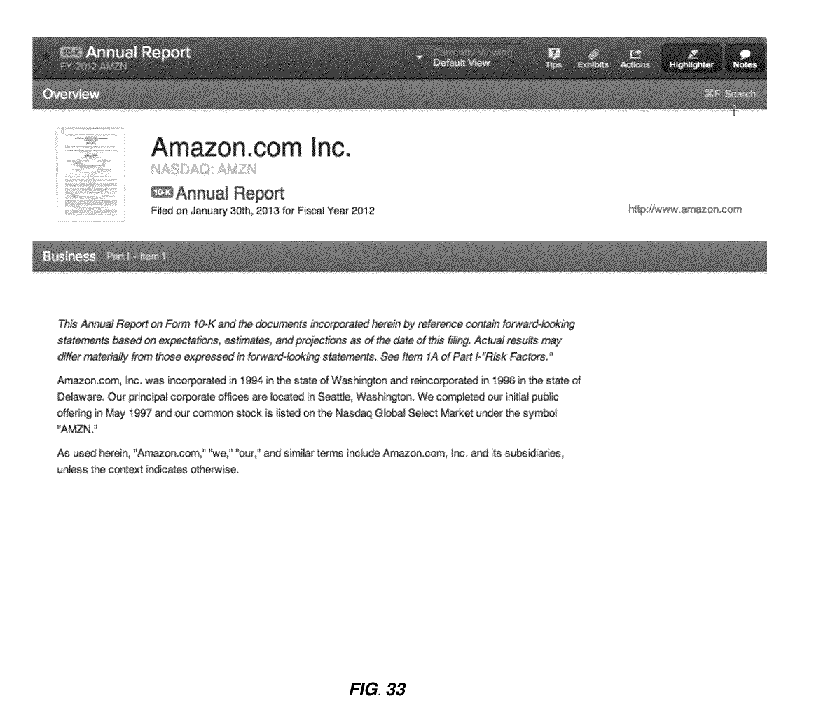

FIGS. 33, 34, 35, 36 and 37 illustrate the behavior of the Sticky Section Header, in accordance with one embodiment of the invention.

FIG. 33 shows the beginning of an Annual Report. It has one section—Overview, already stuck to the top, and another one—“Business” —coming up.

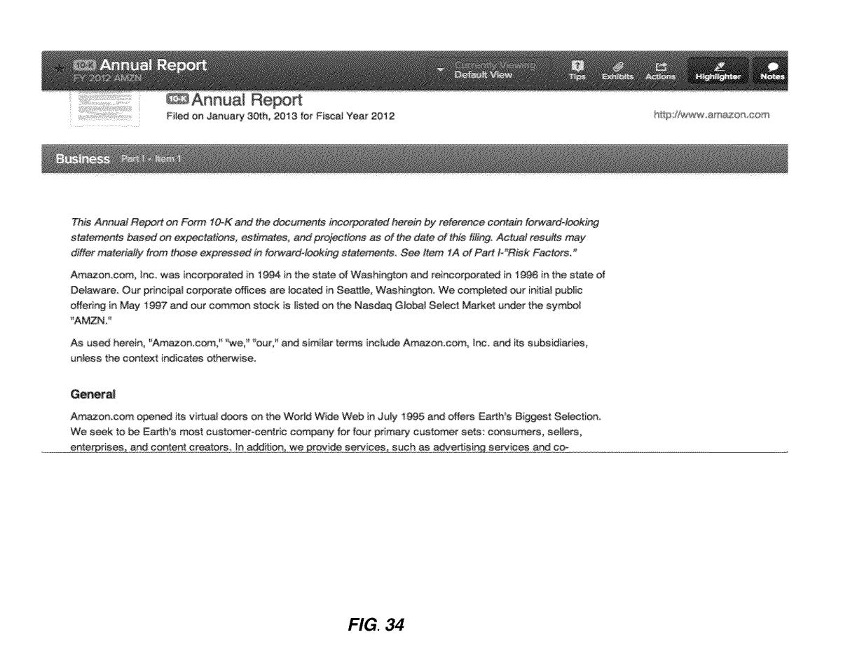

FIG. 34 shows that once the user starts scrolling, the “Overview” title goes away.

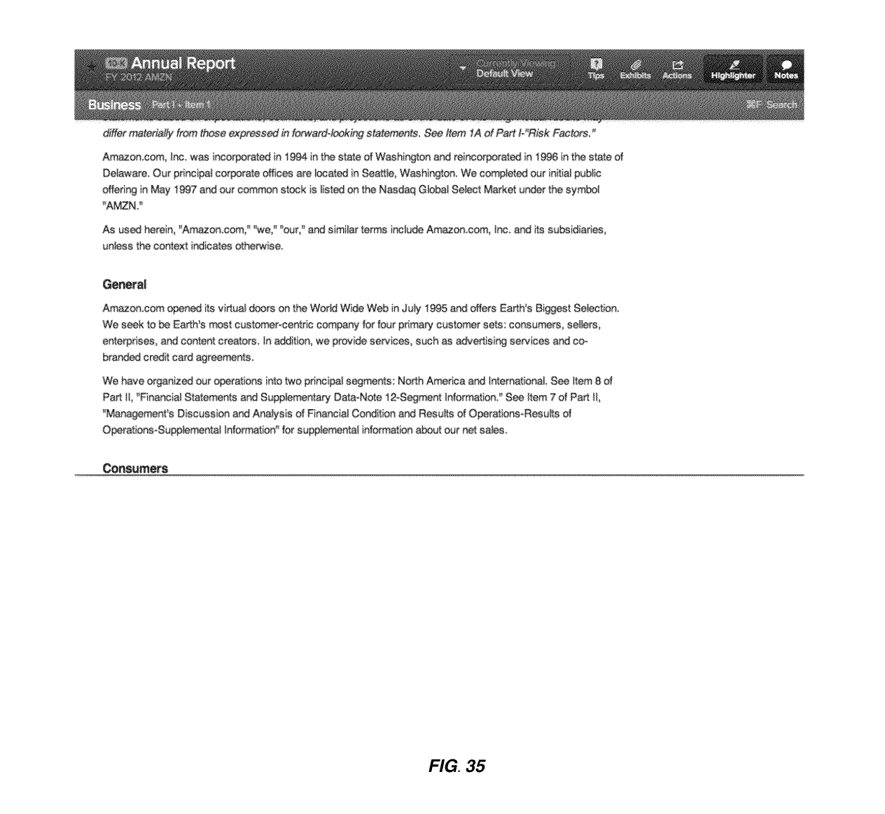

FIG. 35 shows that eventually the “Overview” title gets replaced by the “Business” title.

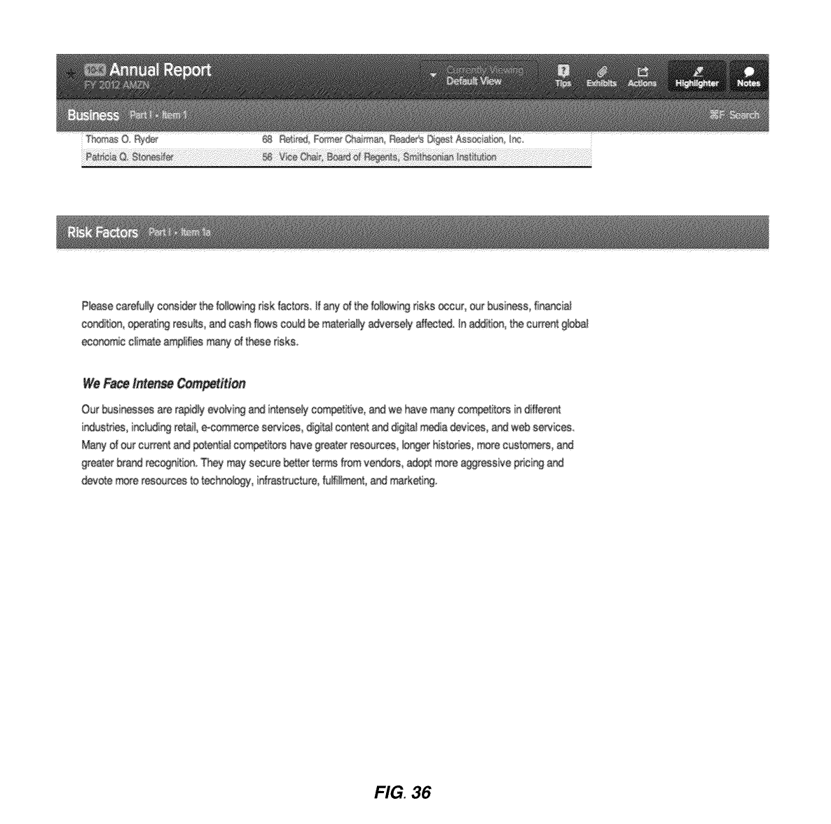

FIG. 36 shows that as the user continues to scroll and approaches the next title (Risk Factors”), eventually the same thing happens. Up to a certain vertical spacing between the two titles, both are visible.

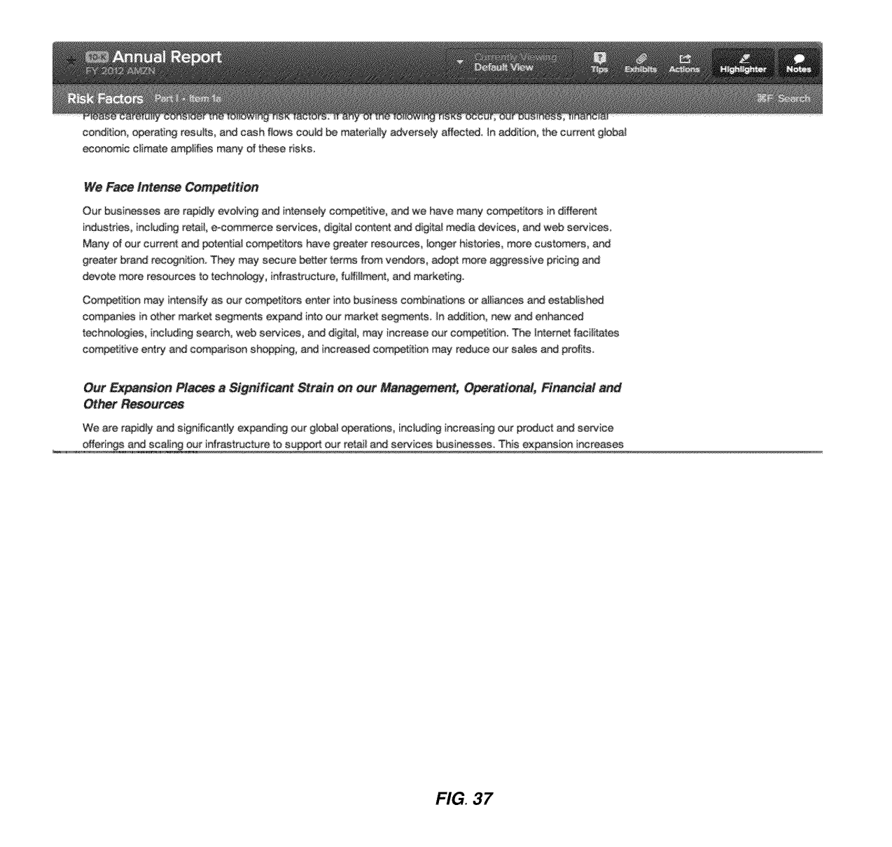

Finally, FIG. 37 shows that the new title replaces the old one and snaps into its place.

The Smart Actions Component C4 may wrap around any objects automatically identified by the Semantic Recognition Engine. It allows for Smart Actions to be performed on the object. Smart Actions available for each object may be hiding the object, printing it, zooming it in and out, and others. Smart Actions can also be object-type specific. For example, if the object is a table, then the Smart Actions can be downloading the table to an external Spreadsheet program, printing the table, editing the table inline, seeing the table's footnotes inline, adding custom calculations to the table, or plotting the table on a chart. If the object is a name of a person, the Smart Actions can be linking to an external competitive research database or to an internal page listing all companies this person is involved in. If the object is a name of a company, the Smart Actions can include linking to an external competitive research database or to an internal company page showing relevant company information; showing a tooltip with context-relevant company information and links. If the object is an event, the Smart Actions can include linking to related news articles or to other companies affected by this event. If the object is a mentioning of a physics law, Smart Actions can include showing a tooltip explaining the law, linking to an external resource explaining it, or showing custom visualizations of the law.

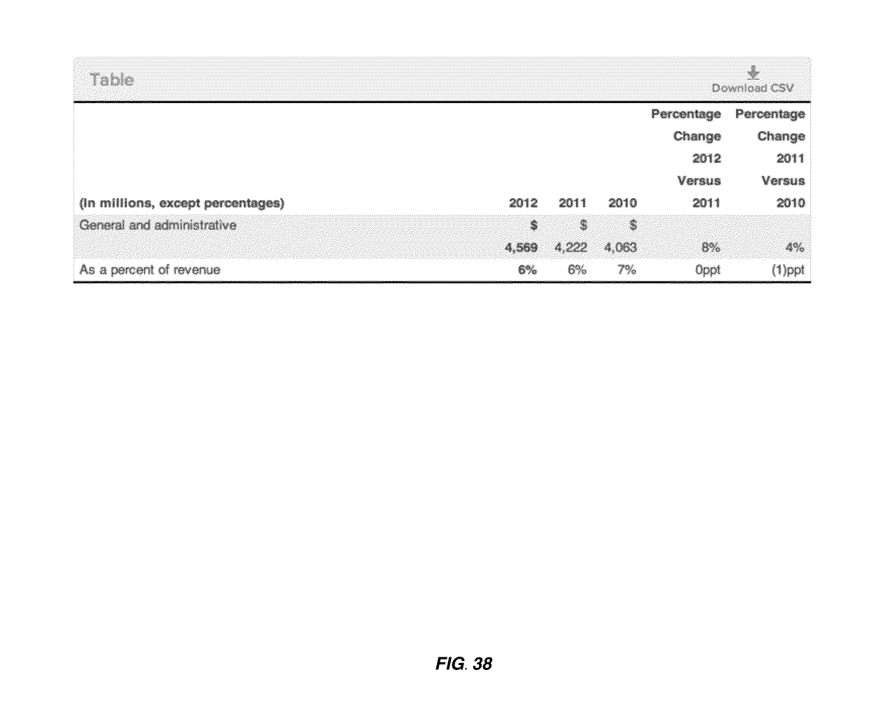

FIG. 38 illustrates one smart action on a table: Downloading to CSV.

The Smart Actions Component uses the Smart Actions Database DB4 for these purposes. The way the Smart Actions Database is compiled is out of scope for this document, but we should mention that it could be licensed, manually created by humans or automatically compiled by other software systems (as well as any combination of the above).

### Annotation

The user uses the Semantic Annotation Component to highlight and/or annotate areas of the document. Highlights and annotations allow the user to capture any thoughts, comments, questions, concerns, additional filings, etc. in-place while reading the document.

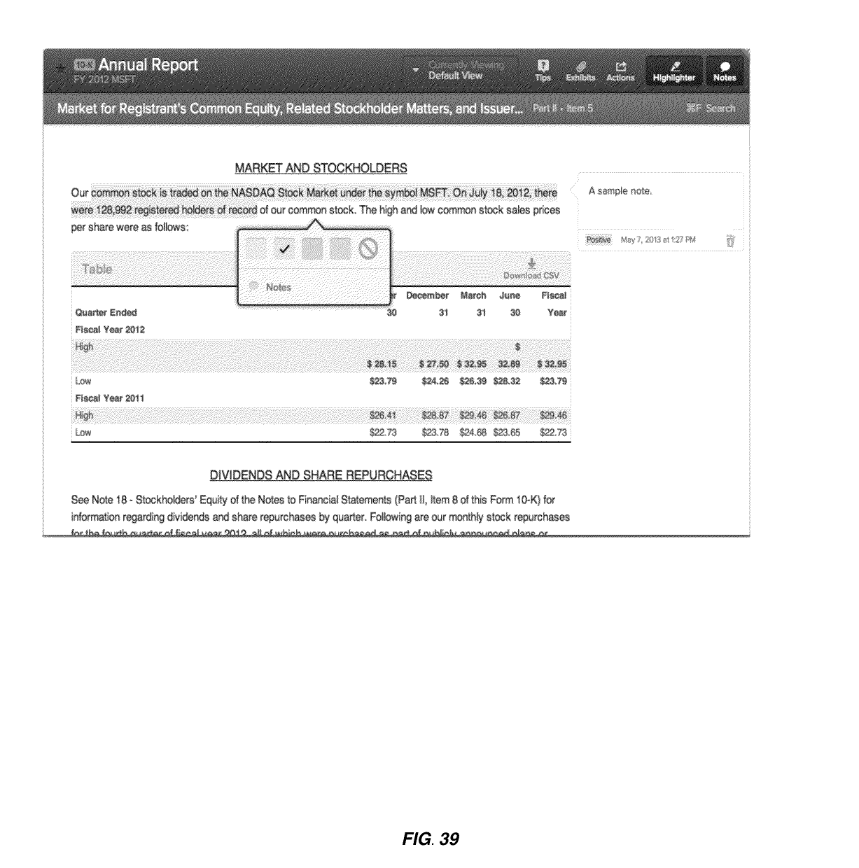

FIG. 39 shows a sample screen of the Document Viewing Component along with all the elements of the Semantic Annotation Component.

In one embodiment, the Semantic Annotation Component may comprise:

1) A Highlighter Toggle, which turns highlighting on/off and can also change the default semantic highlighter.
2) An Annotations Menu, which allows the user to change the semantic highlight type of an annotation, to create a note, or to delete the annotation. The Annotations Menu consists of:
2A) Several Semantic Selectors, which allow the user to change the type of the highlight
2B) A Highlight Delete Action, which deletes the highlight and the Text Note associated with it (if any)
2C) A Notes Button, which creates a Text note for the Annotation (unless one is already created)
   3) A set of Highlights that the user creates. Each highlight has:
3A) A Semantic Annotation Type. Semantic Annotation Types may include but are not limited to: Positive, Negative, Research, Highlight, Read later.
3B) Zero or one Text Notes. Each Text Note has the following components: Text, Creation Date and Time, Display (which shows the Semantic Type), and a Note Delete Action, which removes the Note (but not the highlight).

The user can annotate any subsection of the document, including words, sentences, paragraphs, entire tables, cells and cell ranges within tables, images, areas within images, movies, movie frames, and any other objects of interest or parts of such objects. Annotations are passed to the User Data Storage Engine.

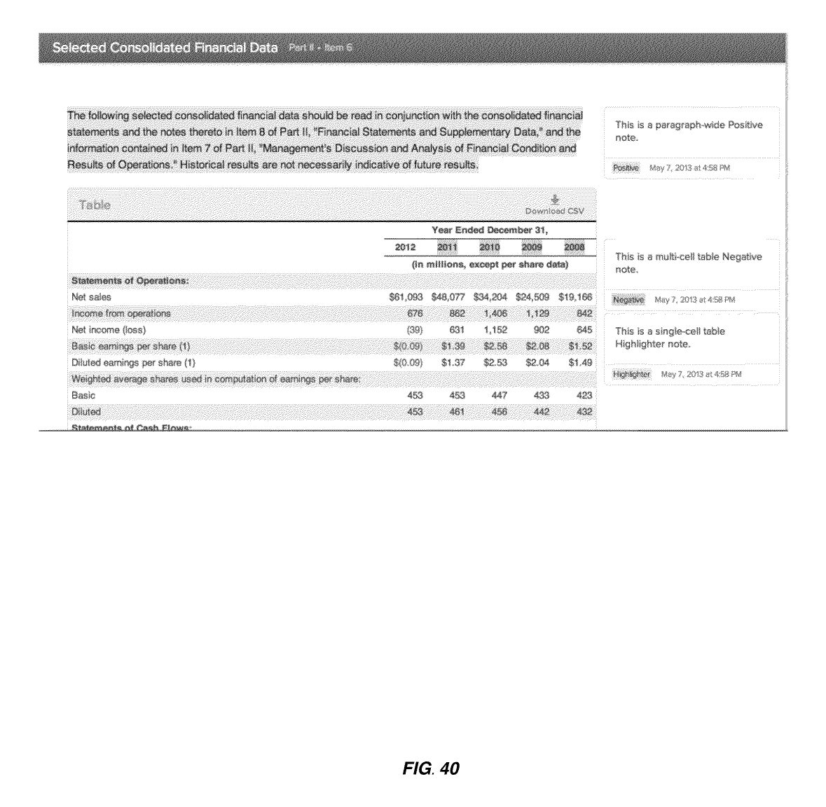

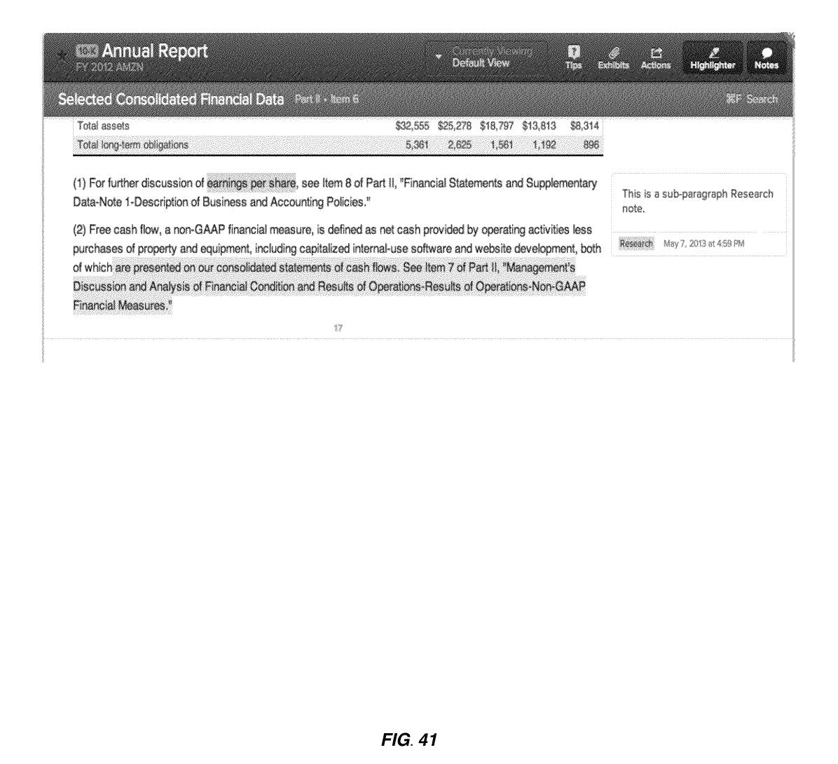

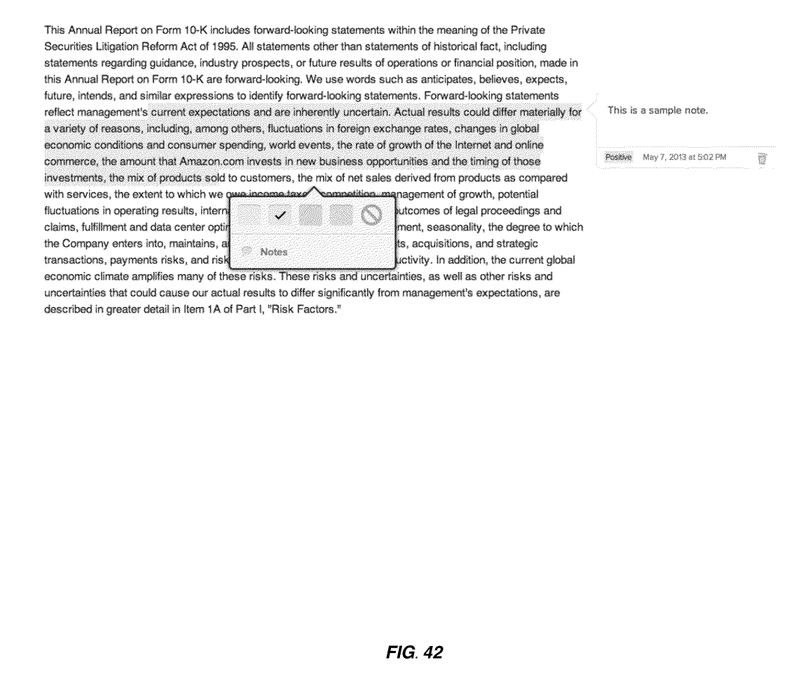

FIGS. 40, 41 and 42 show the Document Viewer with several Semantic Annotations.

Annotations are created by the following series of steps:

1) Select the area of the document to be highlighted
2) The area receives a highlight and a pop-up menu opens up. The same menu can be opened later, by simply clicking anywhere within the annotation
3) The popup menu allows to:
3A) Change the Semantic Color of the annotation (e.g. make it from “Positive” into “Negative”, etc.)
3B) Remove the annotation (deletes both the highlight and the textual note)
3C) Create a textual note (only one per annotation)

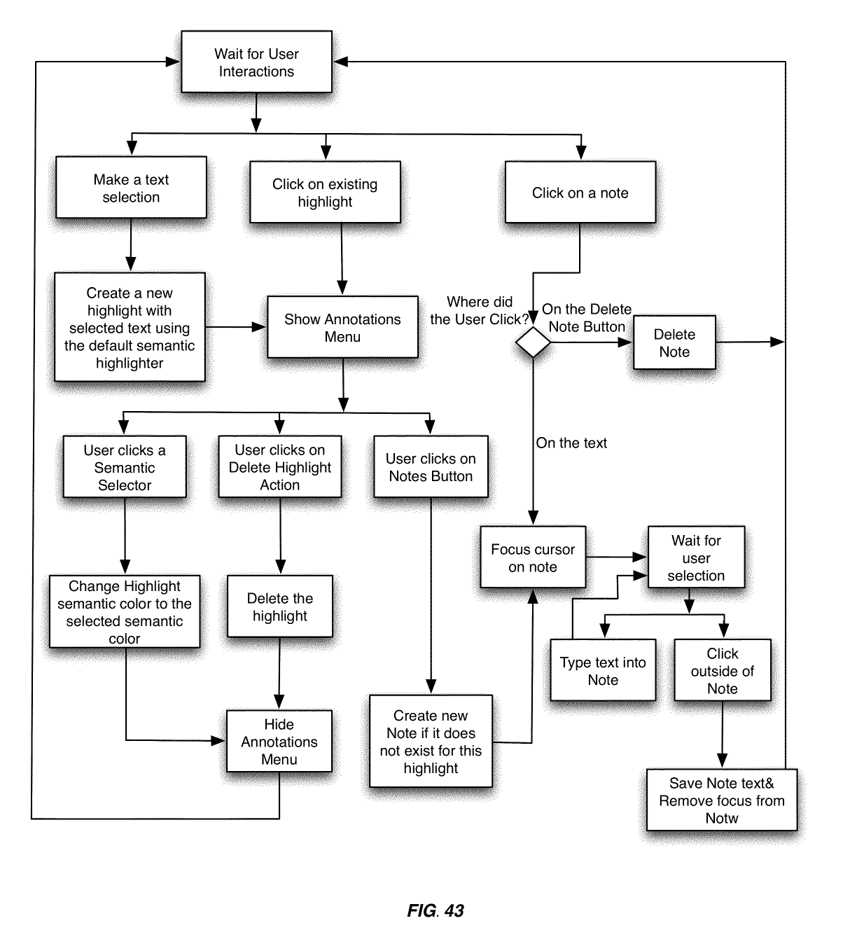

FIG. 43 shows a flowchart for creating Semantic Annotations, in accordance with one embodiment.

The User Data Storage Engine E8 stores the User Actions to the User Data Database.

As it relates to annotations, the following User Actions may be stored:

1) The user creates a highlight
2) The user creates a textual note
3) The user removes a highlight along with the textual note
4) The user removes a text note
5) The user edits a highlight and changes its Semantic Color

### Smart Views

Once the user has opened a document, he can look at it through different “lenses” using the Smart View Component C7. The Smart View Component C7 allows the user to pick any of the pre-canned, user-created or community-created views. Each view is a form of curation on top of the document, and as such it can reorder, rename, shorten, lengthen or exclude any of the sections or sub-sections within the document. The Smart View Component C7 may show views manually created by community users using the View Creation Component C8, as well as views automatically created by the Automatic View Creation Engine.

To illustrate the idea we will use the context of a public company annual report. An annual report filed with the Securities and Exchange Commission typically consists of 20 sections (called “items”) grouped into 4 parts. Each annual report is typically 100 to 200 pages long, and it may become very difficult to find your way through it or, what is even more important, to identify the information that is relevant to you among all the irrelevant information. Some readers only read the chapters related to overall company information, while others are more interested in the chapters related to company financials, and pay close attention to the financial tables. Finally, readers may not necessarily want to read the information in the same sequence in which it was laid out in the original annual report. For example, it may be more useful to them to read Item 8 before Item 4, or Item 12 before Item 7.

Another example comes from the domain of patents. A patent typically consists of several sections, most commonly: Abstract, Drawings, Related applications, Background of the invention, Brief description of the drawings, and a Detailed description. This blueprint imposed by common practice and by legislation is not necessarily the most optimal structure for the readers of patents. To some readers, it makes more sense to have the patent claims come before the related applications, or even intertwine the drawings with the text so that they can be reading the text while at the same time looking at the drawings. They may find that a structure that has the abstract first, then the claims, then the detailed description intertwined with the drawings, and finally the related applications/background is a much more convenient layout of the patent.

In both examples, the initial structure of the document (imposed by the author of the document) is not necessarily optimal for the reader. The smart views component thus allows the reader to regain control and choose one of the pre-canned views, manually create their own view, or even use an automatically created view based on the system observing their reading habits. For example, if the system gathers information that the reader always jumps to the “Abstract” section first, then looks at the “Claims” section, and then to “Detailed Description”, it can then propose an automatically assembled Smart View that reorders the document based on user behavior.

More specifically, a “Smart View” consists of the following elements:

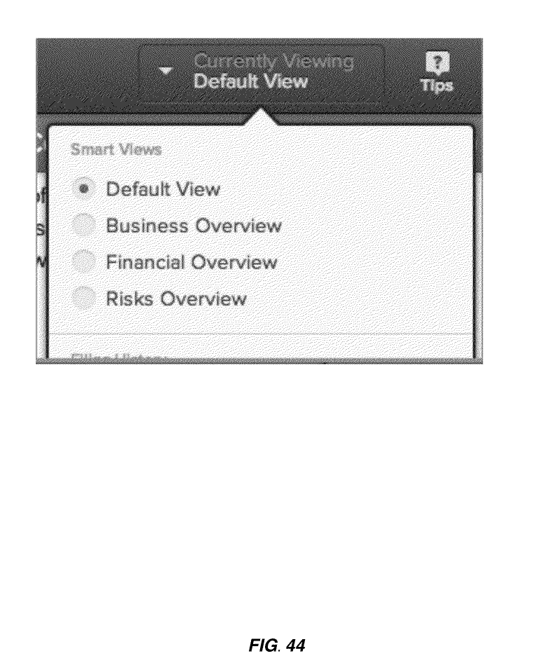

1) A Transformation. The transformation maps, reorders, filters or enriches the original document sections. After the transformation is applied
2) A Name. This name is presented to the user in the UI.
The Smart View Component consists of the following elements (illustrated on FIG. 44):
1) A Display that shows the name of the currently applied Smart View. The Display could be clickable, and clicking on it may open the View Selector.
2) An expandable View Selector, which allows the user to switch to another view
2A) When expanded, the selector shows all views, indicates which view is currently selected, and allows the user to click on the other views
2B) Clicking on the other views changes the currently selected Smart View.

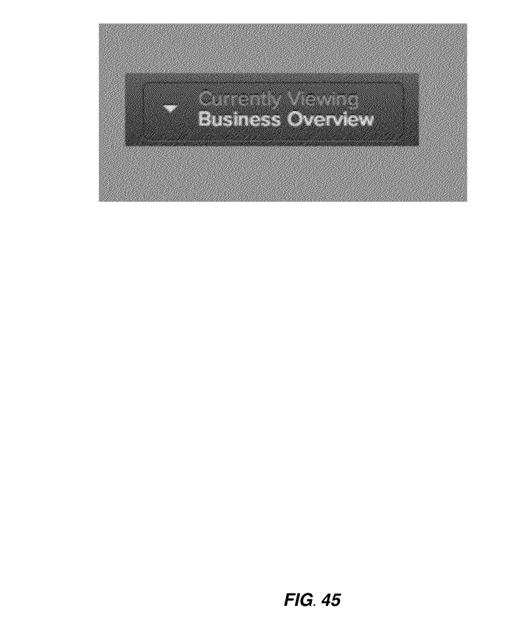

FIG. 45 shows only the Display (the View Selector is not expanded).

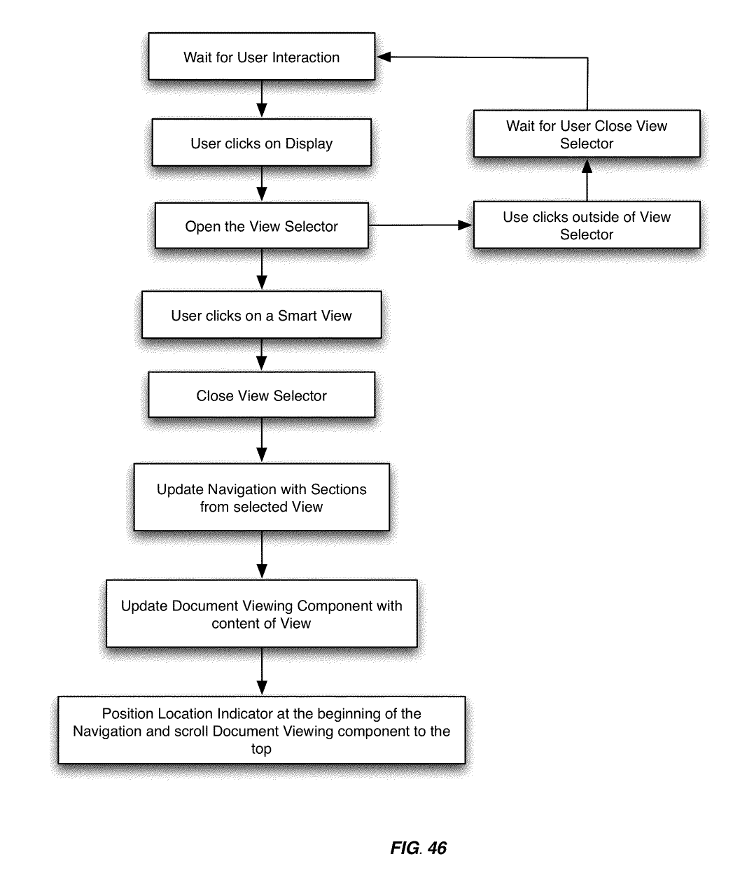

FIG. 46 illustrates a workflow behind the Smart Views Component, in accordance with one embodiment.

The following section provides four specific examples of Smart Views in the context of company Annual Reports.

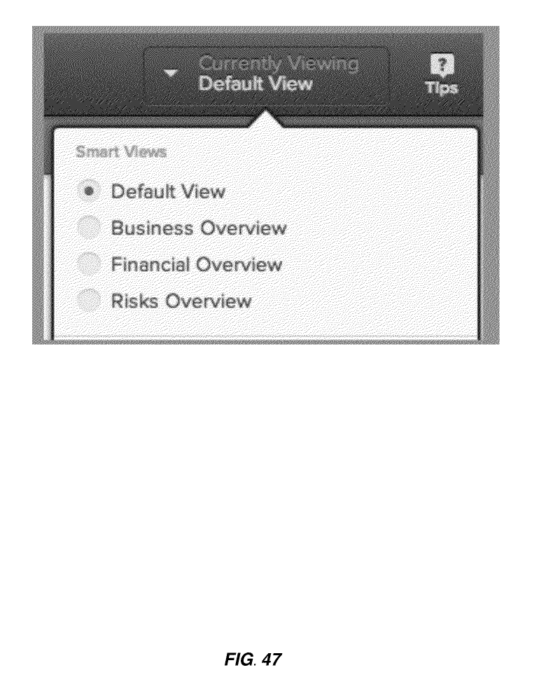

FIG. 47 shows the Smart View Component listing a set of Smart Views for an Annual Report. Four views are shown:

1) The entire document (default view)
2) A “Business Overview” Smart View that only contains three subsections: “Item 1. Business”, and “Item 6. Selected Consolidated Financial Data”. When applied, this view excludes all other subsections from the document, as well as any parent sections. The goal of this view is to distill the most important sections contributing to the overall understanding of the business of the company.
3) A “Financial Overview” Smart View that only contains two subsections: “Item 8. Financial Statements and Supplementary Data” and “Item 5. Market for the Registrant's Common Stock, Related Shareholder Matters and Issuer Purchases of Equity Securities”. Like the “Business Overview”, it removes all other sections. The goal of this view is to include the most important sections for the finance-oriented readers
4) A “Risks Overview” Smart View that only contains four sections—the ones talking about risks the company anticipates.

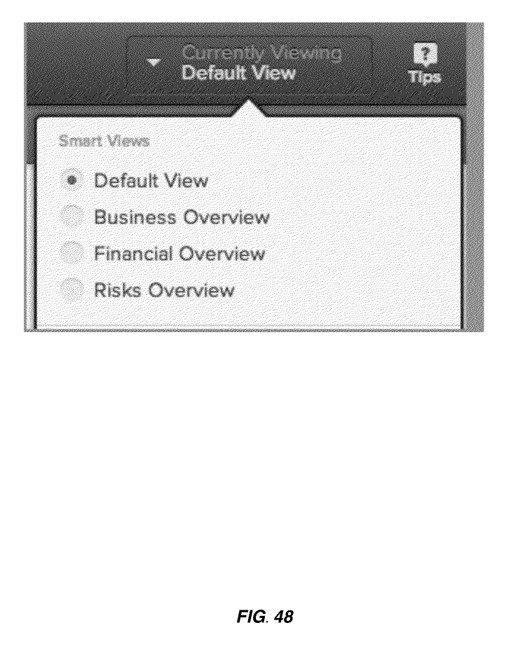

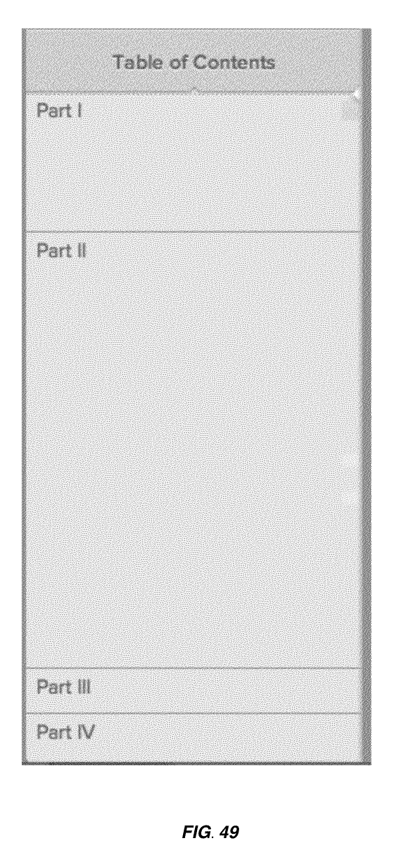

FIGS. 48 and 49 show the Smart View Component and the Navigation Component (respectively) before applying any Smart Views.

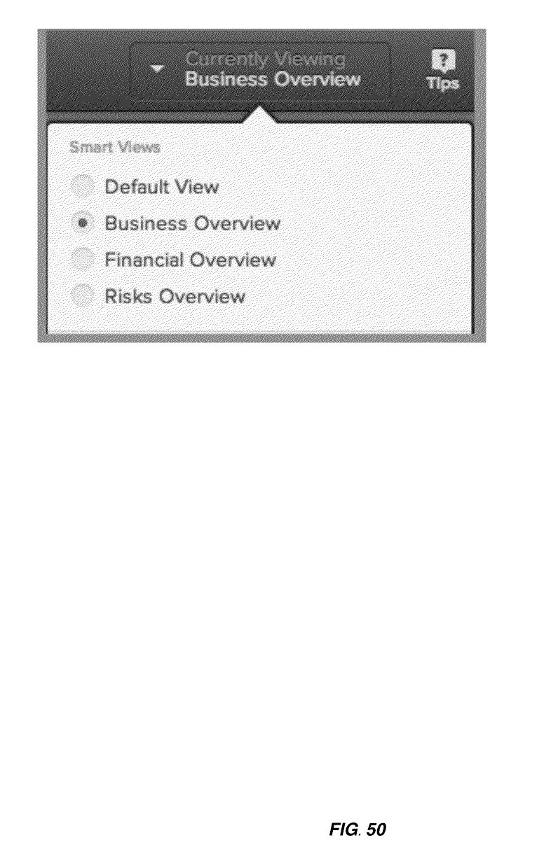

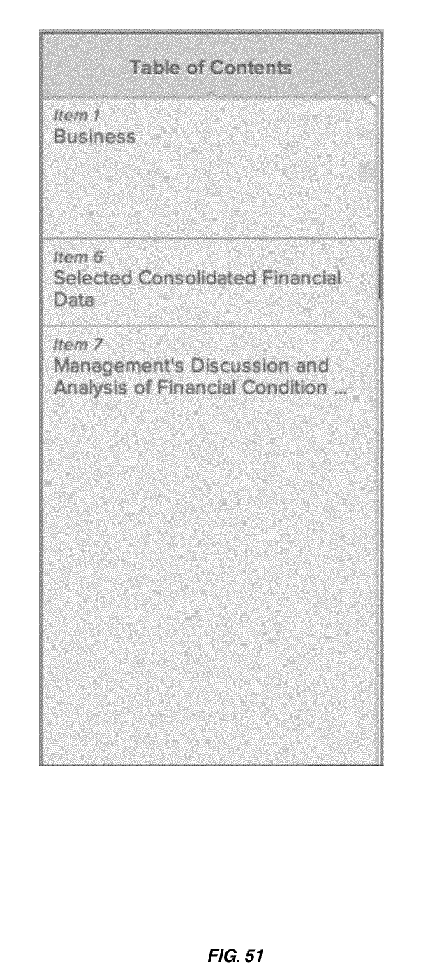

FIGS. 50 and 51 show the same two components after the “Business Overview” smart view has been applied.

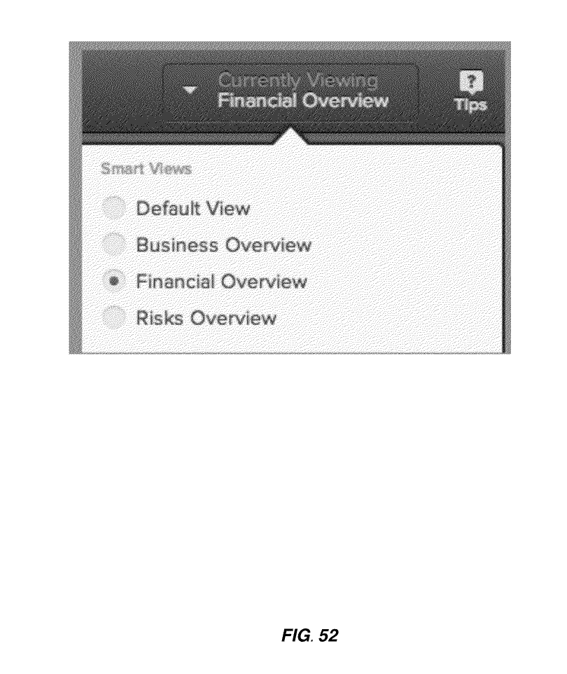

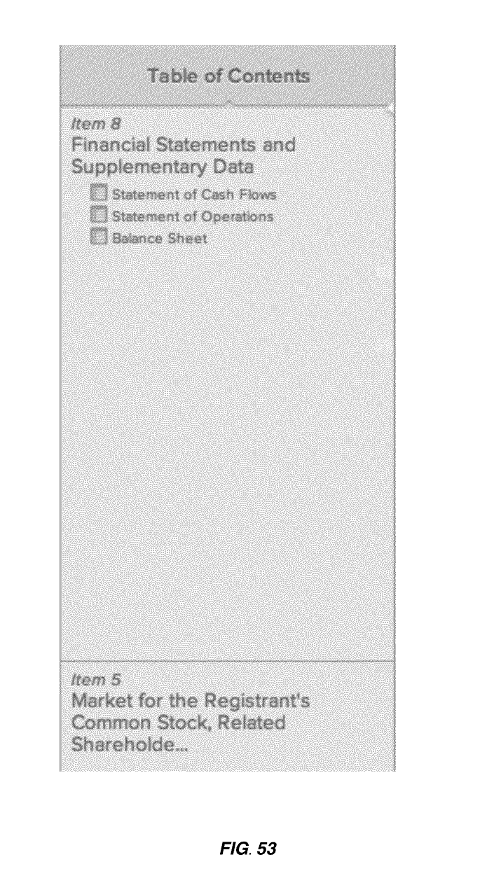

FIGS. 52 and 53 show the same two components after the “Financial Overview” smart view has been applied.

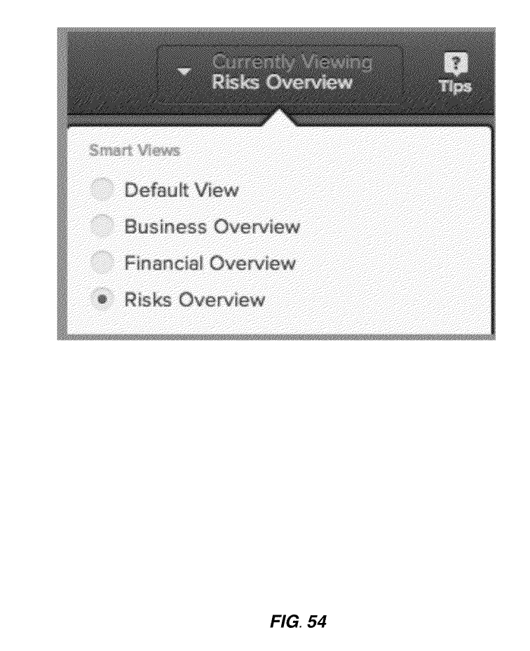

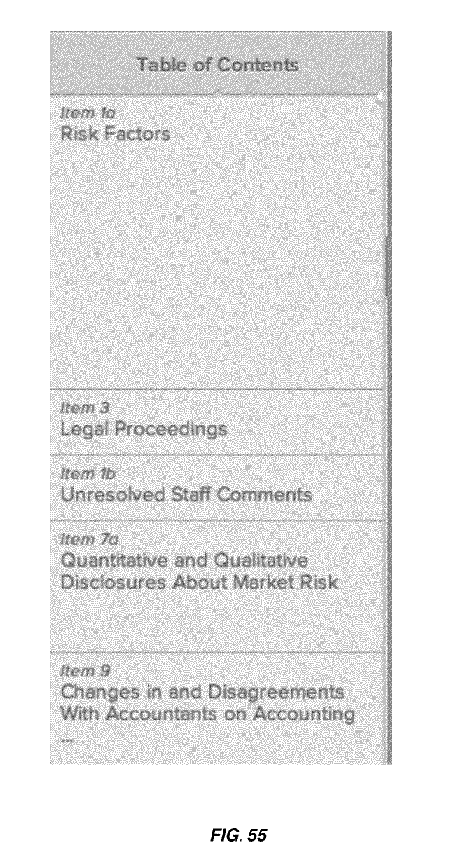

FIGS. 54 and 55 show the same two components after the “Risks Overview” smart view has been applied.

Using the View Creation Component C8 the user can create Smart Views. The component allows the user to remove sections, reorder them, rename them, or to otherwise edit them. The View is then used as a template on any further documents of the same type. Views can be shared with the community using the View Sharing Component.

The View Sharing Component C11 allows the user to mark a custom created View with the rest of the community. Other users of the community can then select the newly created view using the Smart View Component.

### Usage Tracking

As each user uses the system, the Usage Tracking Engine E9 tracks usage behavior and patterns. It may capture things like:

1) Time spent in each document
2) Time spent in each section
3) Location and semantics (sentiment) of each annotation (created using the Annotation Creation Component)
4) Preferred view (selected from the Smart View Component)
5) Path through the document (order in which sections are visited)
6) Reading progress (which sections have been read by the user)
7) Smart Actions usage

The Usage Tracking Engine E9 may store such data in the Usage Tracking Database.

The Document Recommendation Engine E7 uses the data in the Usage Tracking Database to identify documents that may be useful, interesting or otherwise appropriate for the particular user. The recommendations are then displayed by the Document Selection Component. For example, if a user is identified by the Recommendation Engine to have similar interests to a cohort of other users, and these users have seen a document this user has not seen, the Recommendation Engine may recommend this document to the user. Another example would be if a user has viewed several documents by a specific author or on a specific topic, and a new document has been added to the system. This document may be considered of interest to the user and hence recommended.

The Automatic View Creation Engine E6 uses the Usage Tracking Database to extract usage patterns and construct new views based on them. These views can then be shown in the Smart View Component.

### Document Differences

The Document Difference Analysis Engine E5 compares two documents and extracts structural and semantic differences between them. These differences can be as simple as change of formatting, text addition or deletion, or as complicated as a new semantic object being added, removed or modified. Examples include adding a new risk factor to a company's annual SEC report, acquisition of a new property reported inside a company's annual SEC report as compared to last year's, introducing a new chapter in a book, revising the numbers within a financial table, fixing a mistake inside a physics law formula, and others.

Using the Document Difference Component C13 the user can choose a sequence of two or more documents, which are then fed into the Document Difference Analysis Engine. These documents are assumed to already be inside the Document Database—if they are not, the user uses the Document Submission Component to input them into the system. The Engine analyses each pair of consecutive documents and reports the changes between them. The Document Difference Component then displays a visual “timeline” of changes, effectively telling the evolution story starting at the first document and ending at the last one.

### Recording

The Recording Component C12 allows the user to record their actions with the document, synchronized with their voice and video. The newly created recording is passed to the User Data Storage Engine.

### Social

Users can use the Document Sharing Component C5 to share a document along with their work (e.g. annotations) with other people.

Users can use the Live Streaming Component C6 to conduct live interactive walk through sessions on the document. Multiple people can join the Live Streaming Component and watch the walk through, ask questions, send comments, etc.

The Social Discussion Component (C14) allows users to write custom commentary related to any area of a document and share it with the community. The commentary can be a question, and answer to a question, a clarification, a criticism, and others. All users can then use the Social Discussion Component to write follow up responses, as well as up-vote and down-vote the quality of each comment. The Social Discussion Component uses the Social Storage Engine (E11) to store and retrieve the discussions from the Social Database. The Social Discussion Component uses the voting data collected to prioritize some discussions over others when displaying them to the user—highest voted comments are shown first, lowest-voted—last.

The Live Chat Component (C15) allows users to see who else is reading the document, and initiate and conduct an informal chat about the document. The Live Chat Component uses the Live Chat Engine (E10) to conduct the chat sessions. The Live Chat Engine uses the Live Chat Database (DB5) to store current and past live chats.

### Applications

In each application, all components of the system remain unchanged. However, applications the System 110 to be more specific in terms of what a document is, as well as what Smart Objects and Smart Actions are the most useful in each application domain.

### Financial Filings

In this application, each document is an SEC Financial Filing. Publicly registered companies are required to submit regular filings to the SEC. The Reader can be a part of a larger system that allows users to learn more about public companies and their filings, to track their investments, to research competitors and partners, and others. Smart Objects in this application can be financial tables, company logos, signature tables, executive information, risk factors, notes to financial statements, and others.

### Source Code

In this application, each document is a source file in any programming language. The Reader can be used to learn about the code, to conduct code reviews, to record walk through sessions, for technical documentation and others. Smart Objects in this application can be methods, variables, comments, and others. Smart Actions can include executing the code in a method, finding the definition of a variable, and others.

### Patents

In this application, each document is a patent. Smart objects in this application include drawings, steps of a process, figures, claims, cited references, components, and others. Smart actions can include quickly viewing a figure whenever mentioned, rotating or zooming a drawing, jumping to a citation, listing all components.

### Books, Textbooks, Newspapers, Magazines

In this application, each document is a book, a textbook, a newspaper or a magazine. Smart objects in this application include tables, graphs, charts, formulas, embedded videos, pictures, schematics, electric circuits drawings, 3-D models, and others. Smart Actions can include testing formulas with sample values, plotting formula results on sample values, running the electric circuit and seeing the results, opening the 3-D model inside a 3-D plotting program, opening the images inside a photo editing software, and others.

### Others

The Document Reader and the Document Processor disclosed herein can be applied to any field where efficient consumption of large documents is valuable. In addition to the example applications above, additional applications include but are not limited to legislation, medical records, court documents, and others.

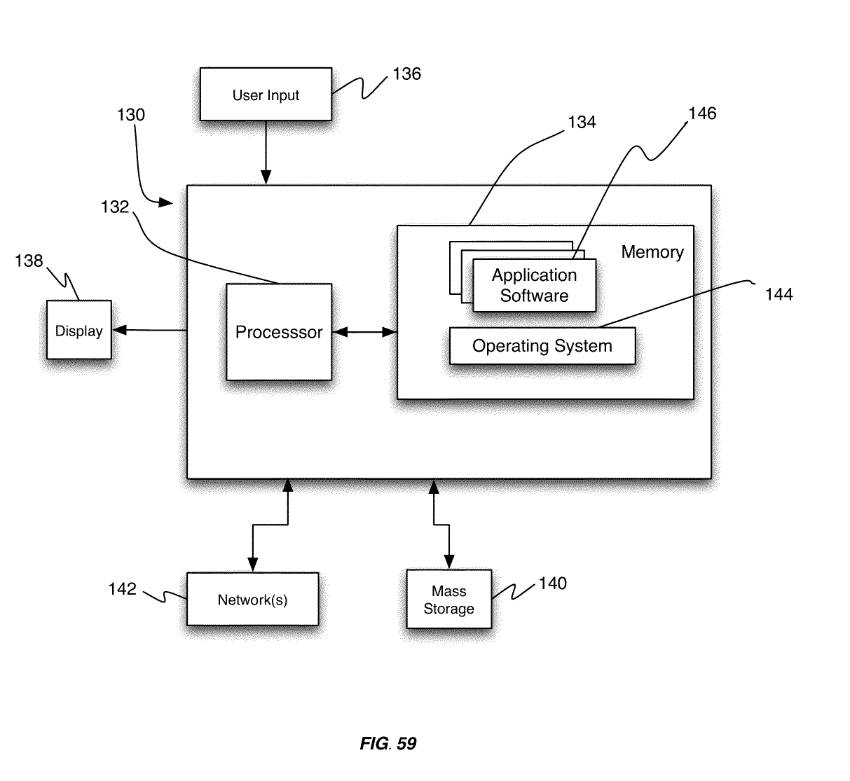

FIG. 59 shows an example of hardware 130 for implementing any of at least some of the components described herein. The hardware 130 may include at least one processor 132 coupled to a memory 134. The processor 132 may represent one or more processors (e.g., microprocessors), and the memory 134 may represent random access memory (RAM) devices comprising a main storage of the system 130, as well as any supplemental levels of memory e.g., cache memories, non-volatile or back-up memories (e.g. programmable or flash memories), read-only memories, etc. In addition, the memory 134 may be considered to include memory storage physically located elsewhere in the system 130, e.g. any cache memory in the processor 132 as well as any storage capacity used as a virtual memory, e.g., as stored on a mass storage device 140.

The system 130 also typically receives a number of inputs and outputs for communicating information externally. For interface with a user or operator, the system 130 may include one or more user input devices 136 (e.g., a keyboard, a mouse, imaging device, etc.) and one or more output devices 136 (e.g., a Liquid Crystal Display (LCD) panel, a sound playback device (speaker, etc.).

For additional storage, the system 130 may also include one or more mass storage devices 140, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 130 may include an interface with one or more networks 142 (e.g., a local area network (LAN), a wide area network (WAN), a wireless network, and/or the Internet among others) to permit the communication of information with other computers coupled to the networks. It should be appreciated that the system 130 typically includes suitable analog and/or digital interfaces between the processor 132 and each of the components 134, 136, 138, and 142 as is well known in the art.

The system 130 operates under the control of an operating system 144, and executes various computer software applications, components, programs, objects, modules, etc. to implement the techniques described above. Moreover, various applications, components, programs, objects, etc., collectively indicated by reference 146 in FIG. 59, may also execute on one or more processors in another computer coupled to the system 130 via a network 142, e.g. in a distributed computing environment, whereby the processing required to implement the functions of a computer program may be allocated to multiple computers over a network. The application software 146 may include a set of instructions which, when executed by the processor 132, causes the system 130 to perform the techniques disclosed herein.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific example embodiments, it will be evident that various modifications and changes can be made to these embodiments without departing from the broader spirit of the invention. Accordingly, the specification and drawings are to be regarded in an illustrative sense rather than in a restrictive sense.

1. A system for processing documents, comprising:
at least one component to extract structural information from a document; and
a document selection component capable of selectively rendering the document in accordance with one of a list view and a timeline view based on user-input.
